(19) United States
(12) Patent Application Publication
(10) Pub. No.: US 2017/0007963 A1
(43) Pub. Date: Jan. 12, 2017

(54) NANOFILTRATION MEMBRANE

(71) Applicant: IMPERIAL INNOVATIONS LIMITED, London (GB)

(72) Inventors: Andrew Guy LIVINGSTON, London (GB); Santosh KUMBHARKAR, London (GB); Ludmila PEEVA, London (GB); Joao DA SILVA BURGAL, London (GB)

(21) Appl. No.: 15/114,113

(22) PCT Filed: Jan. 27, 2015
(86) PCT No.: PCT/GB2015/050179

§ 371 Date: Jul. 26, 2016

(30) Foreign Application Priority Data
Jan. 27, 2014 (GB) 1401392.4

(51) Int. Cl. B01D 61/02; B01D 71/52; B01D 67/00

(52) U.S. Cl. CPC B01D 61/027; B01D 67/0011; B01D 71/52; B01D 2325/022; B01D 2325/20; B01D 2325/34

(57) ABSTRACT

Asymmetric integrally-skinned PAEK nanofiltration membranes suitable for nanofiltration of an organic solvent feed stream are disclosed, together with their uses in organic solvent nanofiltration, and their methods of preparation. Membranes are prepared from phase inversion processes and are then subjected to a post-manufacturing heat treatment step in order to arrive at molecular weight cut off characteristics within the nanofiltration region. The membranes exhibit stability over a wide range of p H and temperature.

### INTRODUCTION

The present invention relates to asymmetric integrally-skinned nanofiltration membranes comprising PAEK polymers. The present invention also relates to processes for the preparation of the said membranes, as well as to their uses in nanofiltration applications.

### BACKGROUND OF THE INVENTION

Membrane processes are well known in the art of separation science, and can be applied to a range of separations of species of varying molecular weights in liquid and gas phases (see for example “Membrane Technology and Applications” 2^{nd} Edition, R. W. Baker, John Wiley and Sons Ltd, ISB 0-470-85445-6).

Nanofiltration is a membrane process utilizing membranes whose pores are generally in the range of 0.5-5 nm, and which have molecular weight cut-offs (MWCO) in the region of 200-2000 Da. MWCO of a membrane is generally defined as the molecular weight of a molecule that would exhibit a rejection of 90% when subjected to nanofiltration by the membrane. Nanofiltration has been widely applied to filtration of aqueous fluids, but due to a lack of suitable solvent stable membranes has not been widely applied to the separation of solutes in organic solvents. This is despite the fact that organic solvent nanofiltration (OSN) has many potential applications in the manufacturing industry, including solvent exchange, catalyst recovery and recycling, purifications, and concentrations.

OSN membranes have been known since the 1980s. In spite of this, there is still a very limited number of commercial membranes available on the market, with the majority of them being based on polyimide materials (PI). Non-cross-linked PI have been shown to give good performances in several organic solvents (including toluene, heptane, hexane, methanol, ethyl acetate, etc.), however polyimides are unstable in some amines and have generally poor stability and performance in polar aprotic solvents and chlorinated solvents such as methylene chloride (DCM), tetrahydrofuran (THF), dimethyl formamide (DMF) and n-methyl pyrrolidone (NMP), in which most polyimides are soluble. Cross-linking of PI OSN membranes increases their solvent resistance and can offer long term stability in some polar aprotic solvents including acetone, tetrahydrofuran and dimethylformamide. However, such membranes are often unsuitable for use in chlorinated solvents, or with strong amines, or strong acids and bases [1,2]. Moreover, the recommended maximum operational temperature for such membranes is only 50° C., which poses serious limitations for implementing OSN in, for example, catalytic processes. Typically, such catalytic reactions are performed at high temperatures (100° C. and above) in aggressive solvents (e.g. DMF), and at high concentrations of acid or base, meaning that only the most stable OSN membranes will be suitable. Whilst ceramic membranes have been shown to possess higher tolerances towards organic solvents and elevated temperatures, their suitability is hampered by their brittle structure, as well as processing difficulties, which make it difficult to achieve the desired nanofiltration characteristics.

To date, attempts to improve the resistance of polymeric membranes to organic solvents have focused predominantly on cross-linking, for example with PI, polyaniline, polyacrylonitrile and polybenzimidazole materials. Another approach has been to use an intrinsically solvent resistant polymeric material, such as poly(ether ketone) (PEK) or poly(ether ether ketone) (PEEK). PEK and PEEK are known in the art as forming part of the poly(aryl ether ketone) (PAEK) family.

PEEK (poly(oxy-1,4-phenylene-oxy-1,4-phenylenecarbonyl-1,4-phenylene)) is a semi-crystalline, high performance thermoplastic with a rigid aromatic backbone structure constituted of a hydroquinone and a benzophenone segment. It possesses good mechanical and thermal properties (glass and melt transition temperatures of 143° C. and 340° C. respectively), broad chemical resistance, oxidation stability and passive biocompatibility [3-6]. In spite of this, the use of PEEK in OSN membranes has proved problematic due to processing difficulties.

The rigid, semi-crystalline structure of PEEK translates to poor solubility in organic solvents. This has a negative bearing on OSN manufacturing processes which typically require the preparation of a homogenous polymeric solution, which is then cast or extruded into the desired geometry. Attempts at improving the solubility of PEEK have focussed on disrupting the polymer's crystallinity by modification of the rigid backbone with various groups. Enhanced solubility has been achieved by increasing the degree of sulphonation of the PEEK polymer by immersion in sulphuric acid, as shown below:

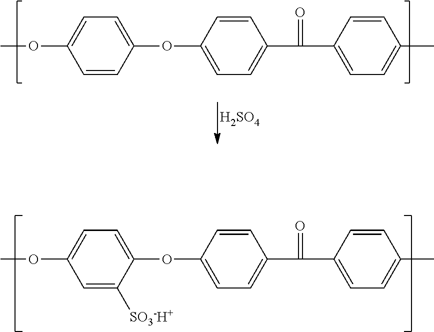

However, whilst increasing the degree of sulphonation facilitates membrane manufacture by allowing preparation of an initial solubilized polymer solution, the enhanced solubility properties of the sulphonated PEEK polymer have negative consequences for the solvent stability of the finished membrane. Accordingly, heavily sulphonated PEEK polymer membranes are often highly soluble in organic solvents.

Hendrix et al. (Journal of Membrane Science, Volume 447, 2013, Pages 212-221) teaches that it is not possible to prepare phase inversion membranes from native PEEK since it is not soluble in common polar aprotic solvents, although introducing a functional group that ensures solubility can overcome this. This document further teaches that a well-selected functionality, in this case diphenolic acid, can then be used for subsequent crosslinking to prepare a solvent-stable PEEK.

Hendrix et al. (Journal of Membrane Science, Volume 447, 2013, Pages 96-106) provides solvent resistant nanofiltration membranes comprising PEEK, in which the polymer backbone was modified with a tertiary butyl group to improve solubility.

Hendrix et al. (Journal of Membrane Science, Volume 452, 2014, Pages 241-252) discloses bisphenol A-, and tertiary butyl-, modified PEEK derivatives having improved solubility compared to native PEEK, thereby allowing the preparation of solvent resistant nanofiltration membranes by phase inversion.

In addition to solubility-related processing difficulties, research in the field of polymer membranes has highlighted the difficulties of achieving either modified PAEK polymer membranes, or unmodified “native” PAEK polymer membranes, having molecular weight cut off properties in the nanofiltration range.

The present invention was devised with the foregoing in mind.

### SUMMARY OF THE INVENTION

According to a first aspect of the present invention there is provided an asymmetric integrally-skinned nanofiltration membrane comprising a PAEK polymer, wherein the membrane has a degree of sulphonation of less than 40% and is suitable for performing nanofiltration in a polar aprotic organic solvent.

According to another aspect of the present invention, there is provided a process for the preparation of an asymmetric integrally-skinned nanofiltration membrane comprising a PAEK polymer, the membrane having a degree of sulfonation of less than 40% and being suitable for performing nanofiltration in a polar aprotic organic solvent, wherein the process comprises the steps of:

a) preparing a polymer solution comprising a solubilised PAEK polymer,

b) casting the polymer solution onto a support,

c) performing phase inversion of the cast polymer solution, and

d) exposing the resulting membrane to a temperature of 20-200° C.

According to another aspect of the present invention, there is provided an asymmetric integrally-skinned nanofiltration membrane obtained, directly obtained or obtainable, by any process defined herein.

According to another aspect of the present invention, there is provided a use of an asymmetric integrally-skinned nanofiltration membrane as defined herein for performing nanofiltration in an organic solvent at a temperature of 20-250° C.

### BRIEF DESCRIPTION OF THE DRAWINGS

Embodiments of the invention will be described, by way of example only, with reference to the accompanying drawings, in which:

FIG. 1 is a schematic representation of the 8 cell cross-flow rig used for analysis of membrane performance. In the figure, “P” denotes a pressure gauge; “T” denotes a thermocouple; “F” denotes a flow meter; and “BPR” denotes a back pressure regulator.

FIG. 2 is a graph showing permeance values (L.h⁻¹.m⁻².bar⁻¹) over a period of 24 h for the membranes identified in Table 1 using THF as solvent, without the application of any post-manufacture drying treatment. The flow-rate, temperature and pressure were set at 100 L.h⁻¹, 30° C. and 30 bar, respectively. The error bars represent the standard deviation of the mean. The membranes from different grades are significantly different (p≦0.05, ANOVA).

FIG. 3 is a graph showing rejection values in THF of the different PEEK membranes identified in Table 1 as a function of the molecular weight (M_{w}, g.mol⁻¹) of different polystyrenes after 24 hours, without the application of any post-manufacture drying treatment. The error bars represent the standard deviation of the mean. The membranes from different grades are significantly different (p≦0.05, ANOVA).

FIG. 4 is a graph showing permeance values (L.h⁻¹.m⁻².bar⁻¹) over a period of 24 h for the membranes identified in Table 1 using THF as solvent, wherein the membranes have been subjected to post-manufacture drying treatment at 20° C. The flow-rate, temperature and pressure were set at 100 L.h⁻¹, 30° C. and 30 bar, respectively. The error bars represent the standard deviation of the mean. The membranes from different grades are significantly different (p≦0.05, ANOVA).

FIG. 5 is a graph showing rejection values in THF of the different PEEK membranes identified in Table 1 as a function of the molecular weight (M_{w}, g.mol⁻¹) of different polystyrenes after 24 hours, wherein the membranes have been subjected to post-manufacture drying treatment at 20° C. The error bars represent the standard deviation of the mean. The membranes from different grades are significantly different (p≦0.05, ANOVA).

FIG. 6 is a graph showing permeance values (L.h⁻¹.m⁻².bar¹) over a period of 24 h for the different membranes identified in Table 1 using DMF as solvent, wherein the membranes have been subjected to post-manufacture drying treatment at 20° C. The flow-rate, temperature and pressure were set at 100 L.h⁻¹, 30° C. and 30 bar, respectively. The error bars represent the standard deviation of the mean. The membranes from different grades are significantly different (p≦0.05, ANOVA).

FIG. 7 is a graph showing rejection values in DMF of the different PEEK membranes identified in Table 1 as a function of the molecular weight (M_{w}, g.mol⁻¹) of different polystyrenes after 24 hours, wherein the membranes have been subjected to post-manufacture drying treatment at 20° C. The error bars represent the standard deviation of the mean. The membranes from different grades are significantly different (p≦0.05, ANOVA).

FIG. 8 shows cross-sections SEM images (magnification 300×) detailing the separating layer (magnification 3,300×) of the different membranes identified in Table 1.

FIG. 9 is an ATR-FTIR spectra of PEEK membranes: PM-B, PM-B LS (30) and PM-B HS (30). The arrows show the peaks related to the backbone carbonyl stretching at 1649.5 cm⁻¹, the aromatic C—C stretching at 1488 cm⁻¹, the asymmetric stretching vibration of the O═S═O at 1412 cm⁻¹, and the symmetric stretching vibration of O═S═O at 1220 cm⁻¹.

FIG. 10 is a graph showing degree of sulphonation (%) per mass of polymer determined according to the method described herein for the different PEEK polymer grades and for the PEEK nanofiltration membranes identified in Table 1. The error bars represent the standard deviation of the mean (from two independent samples). S-PEEK 1 is a membrane reported in A. L. Khan et al. (Mixed gas CO₂/CH₄ and CO₂/N₂₂ separation with sulphonated PEEK membranes, 372 (2011) 87-96) for CO₂ separation from gas mixtures containing N₂ or CH₄ and is presented in this figure to emphasise the low DS of the membranes of the present invention.

FIG. 11 shows XRD spectra of the different PEEK polymer grades and the corresponding membranes produced from them.

FIG. 12 is a graph showing contact angle values (°) of polymer/water interface obtained for the PEEK nanofiltration membranes identified in Table 1 according to the method described herein. The error bars represent the standard deviation of the mean (from five independent measurements). All the membranes presented were dried at 20° C.

FIG. 13 is a graph showing degree of sulphonation (%) per mass of polymer determined according to the method described herein for the PEEK nanofiltration membranes identified in Table 2. The numbers in brackets indicate two different pieces of membranes from different dope solutions kept at 20° C. that were cast after 3 days (3) and 30 days (30). The error bars represent the standard deviation of the mean (from two independent samples).

FIG. 14 is a graph showing permeance values (L.h⁻¹.m⁻².bar⁻¹) over a period of 24 h for the different membranes identified in Table 6 using THF as solvent, wherein the membranes were dried directly from water. The flow-rate, temperature and pressure were set at 100 L.h⁻¹, 30° C. and 30 bar, respectively. The error bars represent the standard deviation of the mean. The membranes are significantly different (p≦0.05, ANOVA).

FIG. 15 is a graph showing rejection values in THF of the different PEEK membranes identified in Table 6 as a function of the molecular weight (M_{w}, g.mol⁻¹) of different polystyrenes after 24 hours, wherein the membranes were dried directly from water.

FIG. 16 is a graph showing permeance values (L.h⁻¹.m⁻².bar⁻¹) over a period of 24 h for the different membranes identified in Table 6 using THF as solvent, wherein the membranes were dried directly from IPA (isopropyl alcohol). The flow-rate, temperature and pressure were set at 100 L.h⁻¹, 30° C. and 30 bar, respectively. The error bars represent the standard deviation of the mean. The membranes are significantly different (p≦0.05, ANOVA).

FIG. 17 is a graph showing rejection values in THF of the different PEEK membranes identified in Table 6 as a function of the molecular weight (M_{w}, g.mol⁻¹) of different polystyrenes after 24 hours, wherein the membranes were dried directly from IPA.

FIG. 18 is a graph showing permeance values (L.h⁻¹.m⁻².bar⁻¹) over a period of 24 h for the different membranes identified in Table 6 using THF as solvent, wherein the membranes were dried directly from MeOH. The flow-rate, temperature and pressure were set at 100 L.h⁻¹, 30° C. and 30 bar, respectively. The error bars represent the standard deviation of the mean. The membranes are significantly different (p≦0.05, ANOVA).

FIG. 19 is a graph showing rejection values in THF of the different PEEK membranes identified in Table 6 as a function of the molecular weight (M_{w}, g.mol⁻¹) of different polystyrenes after 24 hours, wherein the membranes were dried directly from MeOH.

FIG. 20 is a graph showing permeance values (L.h⁻¹.m⁻².bar⁻¹) over a period of 24 h for the different membranes of Table 6 using THF as solvent. All the membranes presented were dried from EtOH at different temperatures (20° C., 40° C., 80° C. and 120° C.) prior to their insertion in the cross-flow cells. The flow-rate, temperature and pressure were set at 100 L.h⁻¹, 30° C. and 30 bar, respectively. The error bars represent the standard deviation of the mean.

FIG. 21 is a graph showing permeance values (L.h⁻¹.m⁻².bar⁻¹) over a period of 24 h for the different membranes of Table 6 using THF as solvent. All the membranes presented were dried from n-hexane at different temperatures (20° C., 40° C., 80° C. and 120° C.) prior to their insertion in the cross-flow cells. The flow-rate, temperature and pressure were set at 100 L.h⁻¹, 30° C. and 30 bar, respectively. The error bars represent the standard deviation of the mean.

FIG. 22 is a graph showing permeance values (L.h⁻¹.m⁻².bar⁻¹) over a period of 24 h for the different membranes of Table 6 using THF as solvent. All the membranes presented were dried from acetone at different temperatures (20° C., 40° C., 80° C. and 120° C.) prior to their insertion in the cross-flow cells. The flow-rate, temperature and pressure were set at 100 L.h⁻¹, 30° C. and 30 bar, respectively. The error bars represent the standard deviation of the mean.

FIG. 23 shows XRD spectra of VESTAKEEP 4000P and membranes identified in Table 6.

FIG. 24 is an AFM topographical image of PM-B1.1 of Table 6 dried at 20° C. from water with an area of 1 μm² and 25 μm².

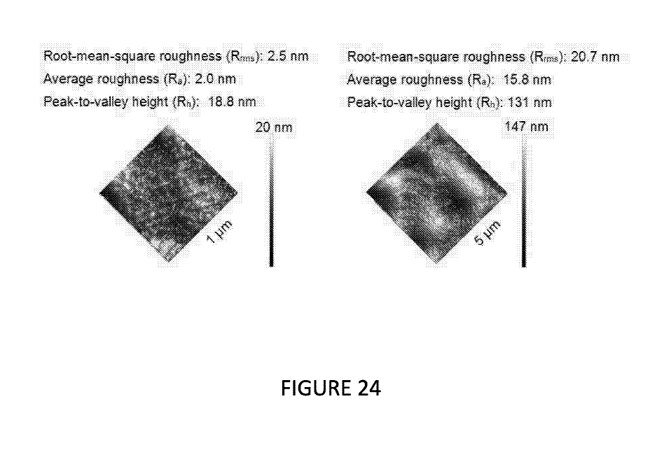

FIGS. 25A1, B1 and C1 show permeance values (L.h⁻¹.m⁻².bar⁻¹) over a period of 24 h for the different membranes of Table 5. A2, B2 and C2 show rejection values of the different PEEK membranes of Table 5 as a function of the molecular weight (M_{w}, g.mol⁻¹) of different polystyrenes after 24 hours. All the membranes presented were dried from water at different temperatures (20° C., 40° C., 80° C. and 120° C.) prior to their insertion in the cross-flow cells. The membranes were filtered with a solution of THF and PS (1 g.L⁻¹). The flow-rate, temperature and pressure were set at 100 L.h⁻¹, 30° C. and 30 bar, respectively. The red bars represent the standard deviation of the mean.

FIG. 26 left: Permeance values (L.h⁻¹.m⁻².bar⁻¹) over a period of 24 h for the different membranes of Table 5. Right: Rejection values of the different PEEK membranes of Table 5 as a function of the molecular weight (M_{w}, g.mol⁻¹) of different polystyrenes after 24 hours. All the membranes presented were dried from water at 120° C. prior to their insertion in the cross-flow cells. The membranes were filtered with a solution of THF and PS (1 g.L⁻¹). The flow-rate, temperature and pressure were set at 100 L.h⁻¹, 30° C. and 30 bar, respectively. The red bars represent the standard deviation of the mean. The membranes dried from water at 120° C. are significantly different (p≦0.05, F-test).

FIG. 27 shows cross-section SEM images (magnification 300 ×) of the different membranes of Table 5: PM-B 8 wt % 120 C, PM-B 10 wt % 120 C and PM-B 12 wt % 120 C.

FIGS. 28A1, B1 and C1 show permeance values (L.h⁻¹.m⁻².bar⁻¹) over a period of 24 h for the different membranes of Table 7. A2, B2 and C2 show rejection values of the different PEEK membranes of Table 7 as a function of the molecular weight (M_{w}, g.mol⁻¹) of different polystyrenes after 24 hours. Membranes PM-B2.x, PM-B3.x and PM-B4.x (x=1,2,3 and 4) were dried from MeOH, EtOH and IPA respectively at different temperatures (20° C., 40° C., 80° C. and 120° C.) prior to their insertion in the cross-flow cells. The membranes were filtered with a solution of THF and PS (1 g.L⁻¹). The flow-rate, temperature and pressure were set at 100 L.h⁻¹, 30° C. and 30 bar, respectively. The red bars represent the standard deviation of the mean.

FIGS. 29D1, E1 and F1 show permeance values (L.h⁻¹.m⁻².bar⁻¹) over a period of 24 h for the different membranes of Table 7. D2, E2 and F2 show rejection values of the different PEEK membranes of Table 7 as a function of the molecular weight (M_{w}, g.mol⁻¹) of different polystyrenes after 24 hours. Membranes PM-B5.x, PM-B6.x and PM-B7.x (x=1,2,3 and 4) were dried from acetone, THF and n-hexane respectively at different temperatures (20° C., 40° C., 80° C. and 120° C.) prior to their insertion in the cross-flow cells. The membranes were filtered with a solution of THF and PS (1 g.L⁻¹). The flow-rate, temperature and pressure were set at 100 L.h⁻¹, 30° C. and 30 bar, respectively. The red bars represent the standard deviation of the mean.

FIG. 30 left: Permeance values (L.h⁻¹.m⁻².bar⁻¹) over a period of 24 h for the different membranes of Table 7. Right: Rejection values of the different PEEK membranes of Table 7 as a function of the molecular weight (M_{w}, g.mol⁻¹) of different polystyrenes after 24 hours. Membranes PM-B1.4, PM-B2.4, PM-B3.4, PM-B4.4, PM-B5.4, PM-B6.4 and PM-B7.4 were dried at 120° C. prior to their insertion in the cross-flow cells from water, MeOH, EtOH, IPA, acetone, THF and n-hexane, respectively. The membranes were filtered with a solution of THF and PS (1 g.L⁻¹). The flow-rate, temperature and pressure were set at 100 L.h⁻¹, 30° C. and 30 bar, respectively. The red bars represent the standard deviation of the mean. The membranes dried from water, MeOH, EtOH, IPA, acetone, THF and n-hexane at 120° C. are significantly different (p≦0.05, F-test).

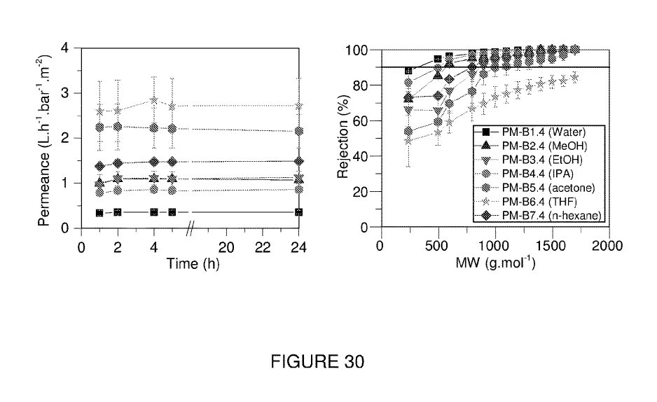

FIG. 31 shows cross-section SEM images (magnification 300×) of the different membranes of Table 7: PM-B1.4, PM-B2.4, PM-B3.4, PM-B4.4, PM-B5.4, PM-B6.4 and PM-B7.4.

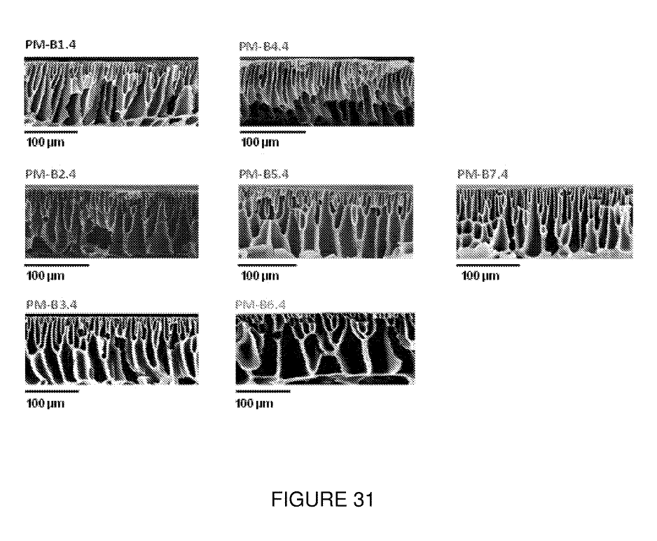

FIG. 32 shows a schematic representation of the high temperature cross-flow rig used in Example 7. Legend: 1—Feed inlet stream; 2—retentate stream; 3—permeate stream; A—HPLC pump; B—hot stirring plate; C—cross-flow cell; P—pressure gauge; T—thermocouple; BPR—back pressure regulator. Note: only one cross-flow is depicted.

FIG. 33 shows a schematic representation of the temperature cycles used in Example 7 as a function of time.

FIG. 34 left: Rejection values (%) for PEEK membranes of Example 7 after 24 h at 30° C., 50° C., 65° C. and cooling down to 30° C. Right: Permeance values (L.h⁻¹.m⁻².bar⁻¹) for PEEK membranes of Example 7 after 24 h at 30° C., 50° C., 65° C. and cooling down back to 30° C. The membranes were filtered with a solution of THF and PS (1 g.L⁻¹).

FIG. 35 left: Rejection values (%) for PEEK membranes of Example 7 after 24 h at 30° C., 85° C., 140° C. and cooling down to 30° C. Right: Permeance values (L.h⁻¹.m⁻².bar⁻¹) for PEEK membranes of Example 7 after 24 h at 30° C., 85° C., 140° C. and cooling down to 30° C. The membranes were filtered with a solution of DMF and PS (1 g.L⁻¹).

FIG. 36 left: Rejection values (%) for PEEK membranes of Example 7 after 24 h at 30° C., 65° C., 100° C. and cooling down to 30° C. Right: Permeance values (L.h⁻¹.m⁻².bar⁻¹) for PEEK membranes of Example 7 after 24 h at 30° C., 65° C., 100° C. and cooling down to 30° C. The membranes were filtered with a solution of toluene and PS (1 g.L⁻¹).

FIG. 37 left: Rejection values (%)for PEEK membranes of Example 7 after 24 h at 30° C., 50° C., 70° C. and cooling down to 30° C. Right: Permeance values (L.h⁻¹.m⁻².bar⁻¹) for PEEK membranes of Example 7 after 24 h at 30° C., 50° C., 70° C. and cooling down to 30° C. The membranes were filtered with a solution of 2-methyltetrahydrofuran and PS (1 g.L⁻¹).

FIG. 38 left: Rejection values (%) for a commercially available polyimide membrane after 24 h at 30° C., 85° C., 140° C. (for 4 hours) and cooling down to 30° C., as described in Example 7. Right: Permeance values (L.h⁻¹.m⁻².bar⁻¹) for a commercially available polyimide membrane after 24 h at 30° C. and 85° C. The membranes were filtered with a solution of DMF and PS (1 g.L⁻¹).

FIG. 39 shows permeance values (L.h⁻¹.m⁻².bar⁻¹) for the membranes PM-B 20% Carbon (20 μm) 20° C. cast on polypropylene (PP) backing and PM-B 20% Carbon (20 μm) 120° C. cast on polypropylene (PP) backing filtered with solutions of THF and PS (1 g.L⁻¹) and n-heptane and PS (1 g.L⁻¹), as described in Example 8. The membranes were first tested in THF and PS, then tested in n-heptane and PS and re-tested in THF and PS. This experiment was conducted in order to verify the influence of the carbon in rejection. The membranes were first tested in THF and PS and then tested in n-heptane and PS.

FIG. 40 shows rejection values (%) of the dimer (MW=236 g.mol⁻¹) for the membranes PM-B 20% Carbon (20 μm) 20° C. cast on polypropylene (PP) backing and PM-B 20% Carbon (20 μm) 120° C. cast on polypropylene (PP) backing filtered with solutions of THF and PS (1 g.L⁻¹) and n-heptane and PS (1 g.L⁻¹), as described in Example 8.The membranes were first tested in THF and PS, then tested in n-heptane and PS and finally re-tested in THF and PS. This experiment was conducted in order to assess the rejection of PS in THF once the membranes were filtered with n-heptane.

FIG. 41 shows contact angle (°) of polymer/water interface obtained for the PEEK nanofiltration membranes of Example 8 (PM-B 20% Carbon (20 μm) 20° C. cast on polypropylene (PP) backing and PM-B 20% Carbon (20 μm) 120° C. cast on polypropylene (PP)). The red bars represent the standard deviation of the mean (from five independent measurements of two different batches). All the membranes presented were dried at either 20° C. or 120° C.

FIG. 42 shows cross-section SEM images of PM-B1.4 of Table 7.

FIG. 43 shows cross-section SEM images of PM-B 20% Carbon 20 μm.

FIG. 44 right: Rejection values (%) for the membranes PM-B with 5% wt. and 20% wt. 50 nm carbon (relative to the polymer mass) dried at 20° C. or 120° C. according to Example 8. Left: Permeance values (L.h⁻¹.m⁻².bar⁻¹) for the membranes PM-B with 5% wt. and 20% wt. carbon (50 nm) dried at 20° C. or 120° C. The membranes were filtered with solutions of THF and PS (1 g.L⁻¹).

FIG. 45 shows cross-section SEM images of PM-B1.4 (Table 7), PM-B 5% wt. 20% 50 nm carbon (relative to the polymer mass) and PM-B 20% wt. 20% 50 nm carbon (relative to the polymer mass) before and after THF+PS filtration at 30 bar and 30° C.

FIG. 46 Top left: Permeance values (L.h⁻¹.m⁻².bar⁻¹) for the membranes PM-B with 0% wt., 5% wt., 20% wt., 50% wt. and 100% wt. 50 nm carbon (relative to the polymer mass) dried at 20° C. or 120° C. Top right: Rejection values (%) for the membranes PM-B with 0% wt., 5% wt., 20% wt., 50% wt. and 100% wt. carbon (50 nm) relative to the polymer mass dried at 20° C. or 120° C., according to Example 8. The membranes were filtered with solutions of THF and PS (1 g.L⁻¹). Bottom left:—Contact angle (°) of polymer/water interface obtained for the for the membranes PM-B with 0% wt., 20% wt., 50% wt. and 100% wt. 50 nm carbon (relative to the polymer mass) dried at 20° C. or 120° C. The red bars represent the standard deviation of the mean (from five independent measurements). Bottom right: XRD spectra of the carbon powder and of the membranes PM-B with 0% wt. and 20% wt. 50 nm carbon (relative to the polymer mass) dried at 120° C.

FIG. 47 Left: Permeance values (L.h⁻¹.m⁻².bar⁻¹) for the membranes PM-B with 1% wt. ZrO2 (relative to the polymer mass) dried at 20° C. or 120° C. Right: Rejection values (%) for the membranes PM-B with 1% wt. ZrO2 (relative to the polymer mass) dried at 20° C. or 120° C. dried at 20° C. or 120° C. The membranes were filtered with solutions of THF and PS (1 g.L⁻¹).

### DETAILED DESCRIPTION OF THE INVENTION

Embodiments of the invention will now be described, by way of example only, for the purpose of reference and illustration.

### Membranes of the Invention

As hereinbefore discussed, in one aspect, the present invention provides an asymmetric integrally-skinned nanofiltration membrane comprising a PAEK polymer, wherein the membrane has a degree of sulphonation of less than 40% and is suitable for performing nanofiltration in a polar aprotic organic solvent. In an embodiment, the present invention provides an asymmetric integrally-skinned nanofiltration membrane consisting essentially of a PAEK polymer, wherein the membrane has a degree of sulphonation of less than 40% and is suitable for performing nanofiltration in a polar aprotic organic solvent. In another embodiment, the present invention provides an asymmetric integrally-skinned nanofiltration membrane consisting of a PAEK polymer, wherein the membrane has a degree of sulphonation of less than 40% and is suitable for performing nanofiltration in a polar aprotic organic solvent.

Asymmetric membranes will be familiar to one of skill in this art, and will be understood to define a polymeric entity composed of a dense ultra-thin “skin” layer mounted atop a thicker porous substructure. When both the skin layer and the porous substructure are made from the same material, the membrane is said to be integrally-skinned.

Membranes of the invention can be used for nanofiltration operations, particularly in organic solvents. By the term “nanofiltration” is meant a membrane process which will allow the passage of solvent while retarding the passage of larger solute molecules when a pressure gradient is applied across the membrane. This may be defined in terms of membrane rejection Rᵢ, a common measure known by those of skill in the art, and defined as:

$${R}_{i} = ( 1 - \frac{{C}_{Pi}}{{C}_{Ri}} ) \times 100 \%$$

where C_{Pi}=concentration of species i in the permeate, permeate being the liquid which has passed through the membrane, and C_{Ri}=concentration of species i in the retentate, retentate being the liquid which has not passed through the membrane. It will be appreciated that a membrane is selectively permeable for a species i if Rᵢ>0. It is well understood by those skilled in the art that nanofiltration is a process in which at least one solute molecule i with a molecular weight in the range 200-2000 g mol⁻¹ is retained at the surface of the membrane over at least one solvent, so that Rᵢ>0. Typical applied pressures in nanofiltration range from 5-50 bar.

The term “solvent” will be understood by the skilled reader and includes an organic or aqueous liquid with a molecular weight of less than 300 Da. It will be understood that the term solvent includes mixtures of solvents.

PAEK will be understood to denote the family of polymers characterised by phenylene rings connected to one another via inter-ring ether linkages and inter-ring carbonyl linkages. Examples of PAEK polymers include poly(ether ketone) (PEK), poly(ether ether ketone) (PEEK), poly(ether ketone ketone) (PEKK), poly(ether ether ketone ketone) (PEEKK) and poly(ether ketone ether ketone ketone) (PEKEKK). It will be further understood that the term PAEK polymer denotes a “native” polymer. By “native”, it will be understood that the polymeric backbone is substantially free of solubilising groups.

In an embodiment, the PAEK polymer is an at least partially crystalline PAEK polymer. By partially crystalline, the skilled person would understand that the level of crystallinity is at least about 5% when calculated by wide-angle X-ray diffraction as described by Blundell and Osborn (Polymer 24, 953, 1983). Suitably, the PAEK polymer has a level of crystallinity of at least 10%.

Suitably, the PAEK polymer is PEEK. PEEK (IUPAC name: poly(oxy-1,4-phenylene-oxy-1,4-phenylenecarbonyl-1,4-phenylene)) will be familiar to one of skill in the art, and will be understood to denote a substantially unmodified, i.e. “native”, PEEK polymer, having the following structure:

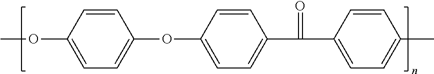

Persons of skill in the art will be equally familiar with the degree of sulphonation of PAEK polymers and how it is calculated. Degrees of sulphonation (DS in %) quoted herein were calculated according to the following equation:

$$D S ( \% ) = \frac{{S}_{E} ( wt \% )}{{S}_{T} ( wt \% )} \times 100$$

in which S_{E} represents experimental ratio of sulphur to carbon in sulphonated PAEK (wt %) and S_{T} represents theoretical ratio of sulphur to carbon in sulphonated PAEK (wt %) for 100% sulphonation.

The membrane of the present invention exhibits a DS value of less than 40%, meaning that its insolubility in a number of organic solvents is preserved, such that it is suitable for nanofiltration applications in a wide variety of organic solvent feed streams, in particular those containing polar aprotic organic solvents. The membrane also exhibits excellent stability in acidic and basic feed streams, as well as in those feed streams having high or low temperatures.

In an embodiment, the membrane has a degree of sulphonation of less than 30%. Suitably, the membrane has a degree of sulphonation of less than 10%. More suitably, the membrane has a degree of sulphonation of less than 8%.

The membrane of the present invention exhibits MWCO values in the region of 200-2000 Da and is therefore suitable for performing nanofiltration of a feed stream.

In an embodiment, the membrane has a MWCO of 100-1000 g mol⁻¹. In a further embodiment, the membrane has a MWCO of 200-750 g mol⁻¹. In another embodiment, the membrane has a MWCO of 375-650 g mol⁻¹. In yet another embodiment, the membrane has a MWCO of 400-600 g mol⁻¹.

In another embodiment, the membrane has a permeance of 0.02-10 L h⁻¹ m⁻² bar⁻¹. In a particular embodiment, the membrane has a permeance of 0.02-1 L h⁻¹ m⁻² bar⁻¹. In a further embodiment, the membrane has a permeance of 0.05-0.9 L h⁻¹ m⁻² bar⁻¹. In a further embodiment, the membrane has a permeance of 0.07-0.8 L h⁻¹ m⁻² bar⁻¹.

In an embodiment, the PAEK polymer used to prepare the membrane has a molecular weight of 10-100 kDa. Suitably, the PAEK polymer used to prepare the membrane has a molecular weight of 25-60 kDa. Suitably, the PAEK polymer used to prepare the membrane has a molecular weight of 30-55 kDa.

In an embodiment, the membrane is formed on top of a porous support. Any suitable porous support material may be used. In an embodiment, the porous support is a material selected from metal mesh, sintered metal, porous ceramic, sintered glass, paper, porous non-dissolved plastic, and woven or non-woven materials. In a particular embodiment, the support is a non-woven material. In a further embodiment, the support is a non-woven polypropylene material. In another embodiment, the support material is a non-woven PAEK material.

In an embodiment, the membrane comprises a conditioning agent. The use of a conditioning agent in accordance with the present invention allows a suitable pore structure to be maintained in a dry state, and produces a membrane having improved flexibility and handling characteristics. Suitably, the conditioning agent is a low volatility organic liquid. More suitably, the conditioning agent comprises at least one compound selected from the group consisting of synthetic oils, mineral oils, vegetable fats and oils, higher alcohols, glycerols and glycols. Even more suitably, the conditioning agent is polyethylene glycol or silicone oil.

In another embodiment, the membrane has a thickness of 30-300 μm. In a particular embodiment, the membrane has a thickness of 30-250 μm.

### Processes of the Invention

As hereinbefore discussed, in another aspect, the present invention provides a process for the preparation of an asymmetric integrally-skinned nanofiltration membrane comprising a PAEK polymer, the membrane having a degree of sulphonation of less than 40% and being suitable for performing nanofiltration in a polar aprotic organic solvent, wherein the process comprises the steps of:

a) preparing a polymer solution comprising a solubilised PAEK polymer,

b) casting the polymer solution onto a support,

c) performing phase inversion of the cast polymer solution, and

d) exposing the resulting membrane to a temperature of 20-200° C.

Membranes of the present invention are prepared by dissolving the desired PAEK polymer in a suitable solvent, which is then cast onto a suitable support, thereby partially evaporating the solvent. The cast polymer solution is then quenched by immersion in a precipitation bath according to a phase inversion process in order to precipitate the polymer, thereby forming an asymmetric integrally-skinned membrane. Finally, the membrane is exposed to a temperature of 20-200° C.

In an embodiment, the membrane is exposed to a temperature of 20-200° C. in an inert atmosphere. In another embodiment, the membrane is exposed to a temperature above the glass transition temperature in an inert atmosphere.

In another embodiment, the membrane is exposed to a temperature of 20-200° C. in air. Optionally, the air may be saturated with a liquid.

In an embodiment, step d) comprises drying the membrane at a temperature of 20-200° C.

In another embodiment, the membrane is exposed to a temperature of 40-200° C. in step d). In still another embodiment, the membrane is exposed to a temperature of 20-140° C. in step d), including 20° C., 40° C., 80° C., 100° C., 120° C. or 140° C. In a particular embodiment, the membrane is exposed to a temperature of 40-130° C. In a further embodiment, the membrane is exposed to a temperature of 60-125° C. In still a further embodiment, the membrane is exposed to a temperature of 80-125° C. In yet another embodiment, the membrane is exposed to a temperature of 80-120° C. It is routine for membranes prepared by wet phase inversion to be stored under wet conditions because the structure of the membrane changes when the membrane is subjected to a drying process. In the case of ultrafiltration and nanofiltration membranes, drying, almost without exception, induces irreversible loss of solvent permeance which is thought to be related with the collapse of the nodular structure of the membrane. The inventors have, however, surprisingly shown that the post-manufacturing step of exposing the membrane to a temperature of 20-200° C. is of vital importance for membrane nanofiltration performance.

Suitably, the membrane is exposed to a temperature of 20-200° C. for a period of 0.1-48 hours. More suitably, the membrane is exposed to a temperature of 20-200° C. for a period of 12 to 24 hours.

Suitably, the PAEK polymer is PEEK.

In an embodiment, following the casting of step b), a portion of the solvent present in the polymer solution may be evaporated under conditions sufficient to produce a dense, ultra-thin top “skin” layer on the PAEK membrane. Suitable evaporation conditions adequate for this purpose include exposure to air for a duration of less than 100 seconds, more suitably less than 30 seconds. In another embodiment, air is blown over the membrane surface at 15-25° C. for a duration of 0-30 seconds.

In an embodiment, step c) of the process is performed by contacting (e.g. immersing) the product of step b) with water. The water in step c) may be replaced several times in order to achieve a pH of 6-7. Suitably the water has a temperature of 5-80° C. More suitably, the water has a temperature of 10-35° C. and most suitably it has a temperature of about 20° C. (e.g. 15 to 25° C.).

In yet another embodiment, step c) is performed in an organic solvent, a mixture of organic solvents, or a mixture of organic solvents with water.

In yet another embodiment, step c) is performed in the presence of additives in the liquid phase, such additives including organic or inorganic compounds.

In another embodiment, prior to step d), the solvent present in the membrane resulting from step c) is exchanged for an alternative solvent by contacting the membrane with the alternative solvent. In a further embodiment, the solvent present in the membrane resulting from step c) is exchanged for an alternative solvent by first contacting the membrane with an intermediary solvent, then contacting the membrane with the alternative solvent. Using a solvent exchange procedure can minimize the risk of nodule collapse during the heat treatment step. In this procedure, the residual solvent present in the membrane after immersion is replaced by an alternative solvent, which is miscible with the solvent present in the membrane and is more volatile such that it can be easily removed by evaporation. When the solvent present in the membrane resulting from step c) and the alternative solvent are not miscible in one another, the solvent exchange proceeds via an intermediary solvent which is miscible in both the solvent present in the membrane resulting from step c) and the alternative solvent. Suitably, the alternative solvent is selected from the group consisting of alcohols, ketones, ethers, esters, alkanes, aromatics and polar aprotics. More suitably, the alternative solvent is selected from the group consisting of isopropyl alcohol, ethanol, acetone, hexane and methanol. Even more suitably, the alternative solvent is isopropyl alcohol. Suitably, the intermediary solvent is isopropyl alcohol.

In another embodiment, the alternative solvent is one or more of methanol, ethanol, isopropyl alcohol, acetone and n-hexane, and step d) involves exposing the membrane to a temperature of 110-130° C. Suitably, the alternative solvent is one or more of methanol, ethanol, isopropyl alcohol, acetone and n-hexane, and step d) involves exposing the membrane to a temperature of 115-125° C.

It will, however, be appreciated that the solvent exchange step is optional and that step d) can be carried out on the product directly obtained from step c). For example, when step c) involves performing phase inversion in water, step d) may involve exposing the resulting membrane to heat treatment without any intermediary solvent exchange step.

In another embodiment, step a) comprises dissolving a PAEK polymer in at least one acid selected from the group consisting of sulphuric acid, liquid hydrogen fluoride, methanesulphonic acid, fluoromethanesulphonic acid, difluoromethanesulphonic acid and trifluoromethanesulphonic acid. Suitably, step a) comprises dissolving a PAEK polymer in a mixture of methanesulphonic acid and sulphuric acid. In an embodiment, the mixture comprises methanesulphonic acid and sulphuric acid in a ratio of 1:0-3:1 wt %. In a further embodiment, the mixture comprises methanesulphonic acid and sulphuric acid in a ratio of 3:1 wt %.

In a further embodiment, the polymer solution in step a) comprises 5-14 wt % of a PAEK polymer. Suitably, the polymer solution in step a) comprises 12 wt % of a PAEK polymer.

In an embodiment, step a) comprises dissolving a PAEK polymer in a mixture of methanesulphonic acid and sulphuric acid, wherein methanesulphonic acid and sulphuric acid are present in the mixture at quantities of 20-90 wt % and 10-95 wt % respectively. Suitably, step a) comprises dissolving a PAEK polymer in a mixture of methanesulphonic acid and sulphuric acid, wherein methanesulphonic acid and sulphuric acid are present in the mixture at quantities of 55-75 wt % and 10-30 wt % respectively.

In an embodiment, step a) comprises preparing a polymer solution consisting essentially of a PAEK polymer. In another embodiment, step a) comprises preparing a polymer solution consisting of a PAEK polymer.

In another embodiment, the polymer solution formed in step a) has a viscosity of 5-80 Pas. In a particular embodiment, the polymer solution formed in step a) has a viscosity of 10-60 Pas.

In another embodiment, prior to step b), the polymer solution formed in step a) is left to stand for a period of 60-200 hours. In a particular embodiment, prior to step b), the polymer solution formed in step a) is left to stand for a period of 60-110 hours.

In another embodiment, step b) comprises casting the polymer solution onto a support selected from metal mesh, sintered metal, porous ceramic, sintered glass, paper, porous non-dissolved plastic, and woven or non-woven materials. In a particular embodiment, the support is a non-woven material. In a further embodiment, the support is a non-woven polypropylene material. In another embodiment, the support is a non-woven PAEK material.

In another embodiment, the polymer solution is cast at a thickness of 30-300 μm. Typically the polymer solution is cast at a thickness of 50-250 μm.

In another embodiment, the process further comprises a step of treating the membrane resulting from step d) with a conditioning agent. Suitably, the membrane is conditioned by contacting it with a conditioning agent dissolved in a solvent, so as to impregnate the membrane. The use of a conditioning agent in accordance with the present invention allows a suitable pore structure to be maintained in a dry state, and produces a membrane having improved flexibility and handling characteristics. Suitably, the conditioning agent is a low volatility organic liquid. More suitably, the conditioning agent comprises at least one compound selected from the group consisting of synthetic oils, mineral oils, vegetable fats and oils, higher alcohols, glycerols and glycols. Even more suitably, the conditioning agent is polyethylene glycol or silicone oil.

### Uses of the Invention

As hereinbefore discussed, in another aspect, there is provided a use of a asymmetric integrally-skinned nanofiltration membrane as defined herein for performing nanofiltration in an organic solvent at a temperature of 20-250° C. The membranes of the invention are insoluble in a number of organic solvents, such that they are suitable for nanofiltration applications in a wide variety of organic solvent feed streams, in particular those containing polar aprotic organic solvents. The membranes also exhibit excellent stability in acidic and basic feed streams, as well as in those feed streams having high or low temperatures.

In an embodiment, the temperature of the organic solvent feed stream is 20-200° C. Suitably, the temperature of the organic solvent feed stream is 20-110° C.

In an embodiment, the organic solvent is a polar aprotic solvent. Suitably, the polar aprotic organic solvent is DMF or THF.

### EXAMPLES

### Example 1

### Membrane Preparation

PEEK powder from two commercial brands was selected: VESTAKEEP® and VICTREX®. Two grades from VESTAKEEP®, 2000P and 4000P, and two grades from VICTREX®, 150P and 450P were used. The polymer powder was dissolved at a concentration of 12 wt. % in a mixture of 3:1 wt. % methanesulfonic acid (MSA) and sulphuric acid (SA) by mechanical stirring (IKA RW 20 digital) at room temperature until complete homogenisation of polymer solution. For each of the polymer grades two polymer dope solutions were prepared and cast onto a non-woven polypropylene. Prior to casting the polymer solution was left 72-96 hours at room temperature until complete removal of air bubbles. The membranes were cast using a bench top laboratory casting machine (Elcometer 4340 Automatic Film Applicator) with a blade film applicator (Elcometer 3700) set at 250 μm thickness. The polymer dope solution obtained was poured into the blade and cast on a polypropylene support (Novatex 2471, Freudenberg Filtration Technologies Germany) with a transverse speed of 0.5 cm.s⁻¹. Following this, the membranes were immersed in deionised (DI) water in a water precipitation bath at 20° C.; the water bath was changed several times until pH 6-7 was reached. A solvent exchange from water to IPA or MeOH was performed for some of the PEEK membranes. Finally, the membranes were left to dry at a temperature of 20-140° C. The viscosity of the dope solution was measured immediately after casting using a rotary viscometer (LV-2020 Rotary Viscometer Cannon instruments, S16 spindle) and all values were recorded at 1 rpm spindle speed and 20° C. All of the membrane formation steps were performed in an air conditioned room set at 20° C. and with a relative humidity (RH) in the range of 30-40%.

Table 1 below summarises the PEEK membranes prepared from two different polymer brands, VESTAKEEP® and VICTREX®, and different polymer grades, 2000P and 4000P for VESTAKEEP®, and 150P and 450P for VICTREX®. The membranes listed below were prepared with the same dope composition: 12 wt. % PEEK polymer, 66 wt. % MSA and 22 wt. % SA. The Mw (kDa) and the viscosity (Pa.$) of the membrane dope solution as well as the spindle speed (rpm) used are presented in this table.

TABLE 1
PEEK nanofiltration membranes of the invention

| | | | | | Spindle |
|---|---|---|---|---|---|
| Membrane | Polymer | Polymer | Mw | Viscosity | speed |
| code | brand | grade | (kDa) | (Pa · s) | (rpm) |
| PM-A | VESTAKEEP ® | 2000P | 32.10 | 35.28 | 1.5 |
| PM-B | VESTAKEEP ® | 4000P | 39.05 | 56.60 | 1.0 |
| PM-C | VICTREX ® | 150P | 38.15 | 14.19 | 4.0 |
| PM-D | VICTREX ® | 450P | 53.33 | 36.88 | 1.5 |

### Membrane Characterisation

### Solubility in Pure Solvents

In order to test the solubility of PEEK membranes in different solvents two pieces of membranes from two batches with the same composition were immersed in DMF, THF, EtOH, acetone, DCM and n-hexane. The membranes were left immersed in the solvents for 7 days and their solubility was checked visually (no weight loss measurement was performed).

### Solubility in Acidic and Basic Solutions

PEEK membranes were immersed in the following aqueous (DI water) solutions: 2 M H₂SO₄, 2 M HCl, 2 M KOH, 25 M NaOH and 16.4 M MEA. The membranes were left immersed in the solutions for 4 months and their solubility was checked by performing a weight loss measurement.

### Molecular Weight Determination

The Mw of the four PEEK polymer grades was determined from viscosity measurements with an Ubbelohde viscometer following the same procedure as Devaux et al. [7]. The concentrations of the solutions (PEEK in sulphuric acid 95 v/v %) were 0.5 g.dl⁻¹, 0.25 g.dl⁻¹ and 0.1 g.dl⁻¹.

### Elemental Microanalysis

PEEK powder and PEEK membranes without the polypropylene support were sent to elemental microanalysis in order to determine the content of C, H, N and S. For C, H, N analysis a CE440 analyser (Exeter Analytical) was used whereas a titration using barium perchlorate was used for determination of S content. From the sulphur content, the degree of sulphonation (DS) was calculated according to the following equation:

$$D S ( \% ) = \frac{{S}_{E} ( wt \% )}{{S}_{T} ( wt \% )} \times 100$$

where, S_{E} represents experimental ratio of sulphur to carbon in SPEEK (wt %) and ST represents theoretical ratio of sulphur to carbon in SPEEK (wt %) for 100% sulphonation. According to [8], sulphonation occurs only on a phenyl ring flanked by two ether groups (A-ring) of the PEEK repeat unit. Further sulphonation (more than one) on the A-ring does not occur under this condition because the acid group exerts an electron-withdrawing effect [8].

### Attenuated Total Reflectance Fourier Transform Infrared Spectroscopy (ATR-FT-IR)

The ATR-FT-IR spectra were recorded on a Perkin-Elmer Spectrum 100 spectrometer equipped with a Universal ATR sampling accessory (diamond crystal), a red laser excitation source (633 nm), and middle infrared (MIR) triglycine sulfate (TGS) detector operating at room temperature. The scans were collected for each sample in the spectral range of 4000-600 cm⁻¹. To improve the signal-to-noise ratios, spectra were recorded with an incident laser power of 1 mW and a resolution of 4 cm⁻¹.

### Contact Angle

Contact angle measurements were performed with an EasyDrop Instrument (manufactured by Kruess) at room temperature using the drop method. This method consists in depositing a drop of water on the surface of a piece of membrane using a micropipette. The contact angle was measured automatically by a video camera in the instrument using drop shape analysis software. At least five independent measurements on different membrane pieces were performed.

### Atomic Force Microscopy (AFM)

Atomic force microscopy was carried out using Veeco AFM Dimension 3100 (Bruker, Calif., USA) equipped with a DAFMLN Dimension AFM Scan Head and a Nanoscope VI controller. Samples were attached on a microscope glass slide using double sided tape. The images were captured under tapping mode using silicon probe (LTESPW, Bruker, Calif., USA) having nominal tip radius of 8 nm with cantilever resonance frequency of 190 kHz and spring constant of 48 N/m. Scan size of 5 μm for standard images (analysis of roughness) and 1 μm for higher magnification images were captured. A sampling resolution of 512 points per line and a speed of 1 Hz were used. Surface roughness is presented as average roughness (Rₐ), root-mean-square roughness (Rᵣₘₛ), and peak-to-valley height (Rₕ).

### Scanning Electron Microscopy (SEM)

For cross-section imaging a membrane sample was broken in liquid nitrogen and pasted vertically onto SEM stubs covered with carbon tape. For surface imaging a membrane sample was cut and pasted horizontally onto SEM stubs covered with carbon tape. The samples were then coated with a chromium-layer in an Emitech K575X peltier under an argon atmosphere to reduce sample charging under the electron beam. SEM pictures of the surface and cross section of membrane samples were recorded using a Scanning Electron Microscope of low resolution (JEOL 6400) at 20KV and under dry conditions at room temperature.

### Example 2

### Membrane Performance and Analysis

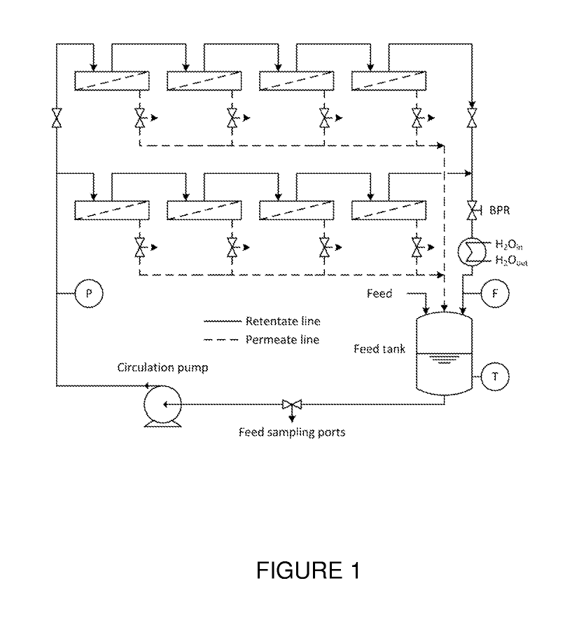

In order to test the membranes a rig with 8 membrane cross-flow cells was used (see FIG. 1). PEEK membranes were initially conditioned by passing pure solvent through at 30° C. and 30 bar (for 1 hour). Polystyrene standard solution was then poured in the feed reservoir and the system was pressurized again up to 30 bar and the temperature set at 30° C. The polystyrene standard solution was prepared by dissolving 2,4-Diphenyl-4-methyl-1-pentene (dimer, M_{w}=236 g.mol⁻¹) and Polystyrene Standards with a M_{w} ranging from 295 to 1995 g.mol⁻¹ (homologous series of styrene oligomers (PS)) in DMF or THF at a concentration of 1 g.L⁻¹ each 2,4-Diphenyl-4-methyl-1-pentene and 1 g.L⁻¹ Polystyrene Standards. Permeate and retentate samples were collected at different time intervals for rejection determination. Concentrations of PS in permeate and retentate samples were analysed using an Agilent HPLC system with a UV/Vis detector set at a wavelength of 264 nm. Separation was accomplished using an ACE 5-C18-300 column (Advanced Chromatography Technologies, ACT, UK). A mobile phase comprising 35 vol. % analytical grade water and 65 vol. % tetrahydrofuran (THF) both containing 0.1 vol % trifluoroacetic acid was used [2].

The flux U), permeance (B) and the rejection (Rᵢ) of PS were determined using the following equations. The corresponding MWCO curves were obtained from a plot of the rejection of PS versus their molecular weight.

$$J [ L \cdot {h}^{- 1} \cdot {m}^{- 2} ] = \frac{Flow rate [ L \cdot {h}^{- 1} ]}{Membrane area [ {m}^{2} ]}$$

$$B [ L \cdot {h}^{- 1} \cdot {m}^{- 2} \cdot {bar}^{- 1} ] = \frac{J [ L \cdot {h}^{- 1} \cdot {m}^{- 2} ]}{Δ p [ bar ]}$$

### Performance in THF

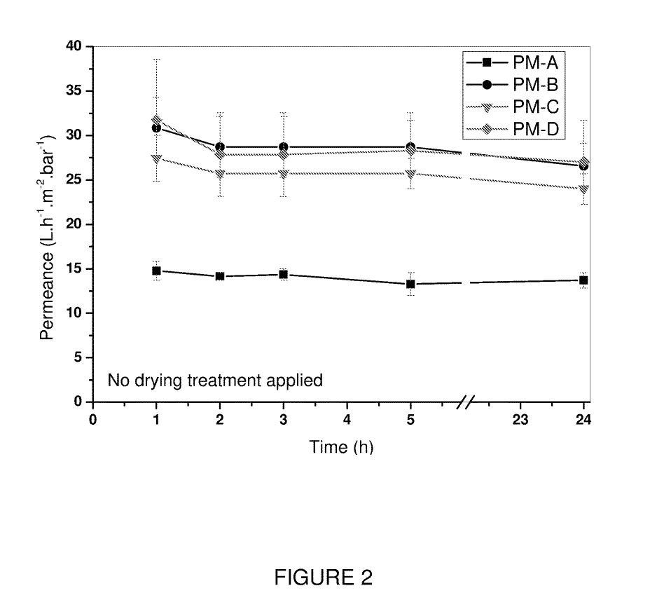

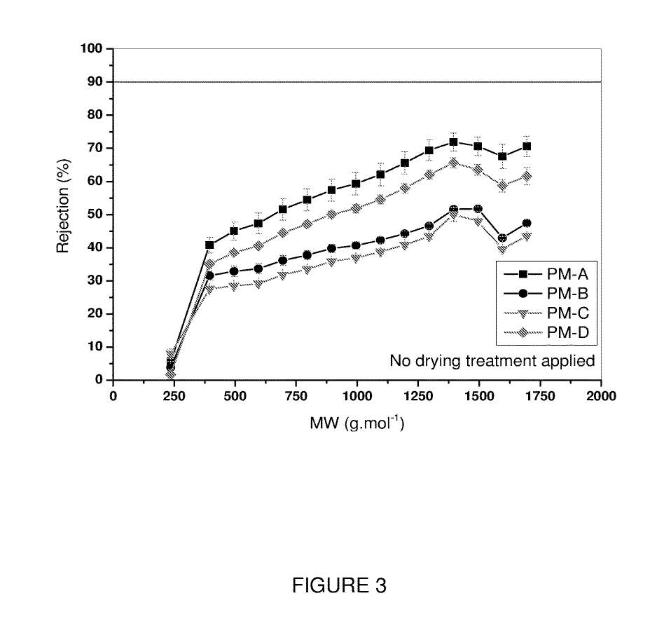

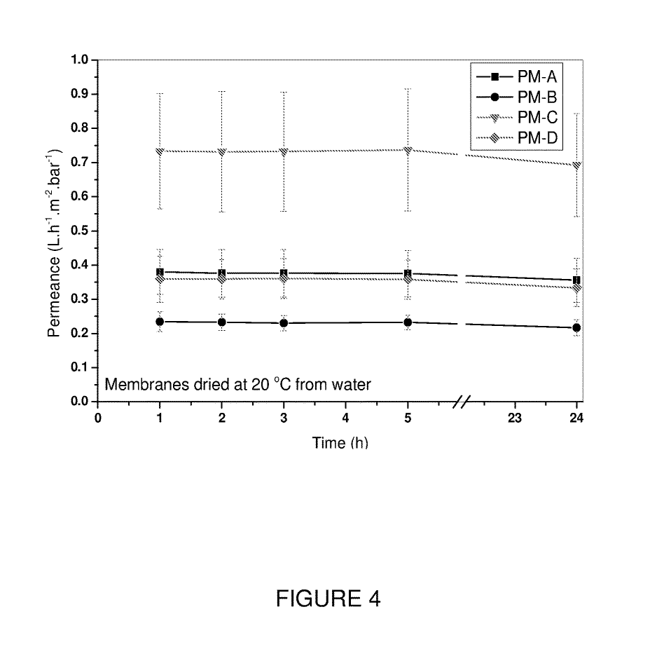

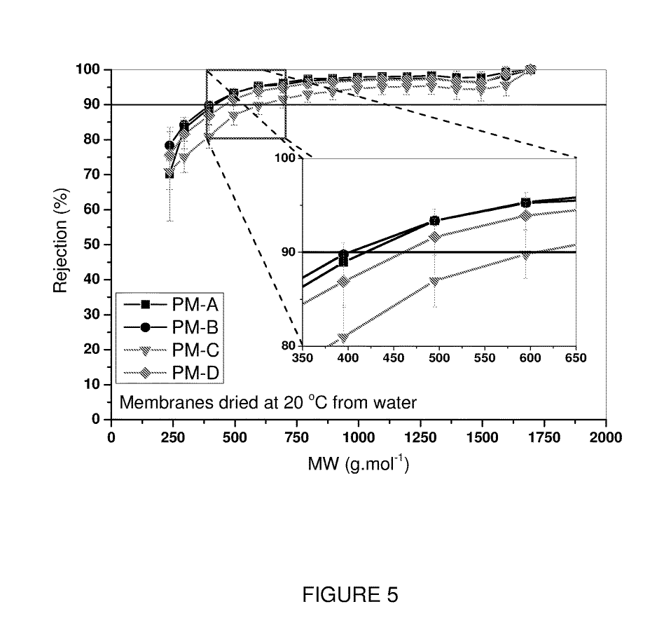

The separation performance of the membranes listed in Table 1 was tested in THF with PS, before and after drying at 20° C., in order to determine the permeance and the MWCO. The results showed that PEEK membranes with nanofiltration properties can only be obtained after drying the wet membranes. This phenomenon can be attributed to a secondary reorganization of the polymeric chains and collapse of the porous structure [9-12]. On the negative side the drying process almost without exception induces irreversible loss of solvent permeance. It can be seen from FIGS. 2 and 4 that the permeance values for membranes PM-A, PM-B, PM-C and PM-D were much higher before drying. On average a decrease of permeance around 36 times was observed for membranes PM-A and PM-C whereas for membranes PM-B and PM-D there was a decrease of permeance of 121 and 82 times respectively. All wet membranes showed low rejection of the PS markers (FIG. 3) and appear to have separation performance within the ultrafiltration range. Upon drying (FIG. 5) the same membranes retain much smaller molecules and exhibit nanofiltration performance. These results underline the importance of the drying process to the formation of nanofiltration membranes.

PM-C, the lowest grade of VICTREX®, presented the highest permeance with a value around 0.7 L.h⁻¹.m⁻².bar⁻¹ but had a MWCO around 600 g.mol⁻¹. PM-B, the membrane with the lowest permeance, 0.22 L.h⁻¹.m⁻².bar⁻¹, had a MWCO of 400 g.mol⁻¹. Both PM-A and PM-D had similar permeances, 0.33 L.h⁻¹.m⁻².bar⁻¹ and 0.38 L.h⁻¹.m⁻².bar⁻¹ respectively but slightly different MWCOs of around 420 g.mol⁻¹ and 460 g.mol⁻¹. To evaluate how significant these differences were an ANOVA test of the results was performed which suggested that the membranes produced from different grades were in fact different from each other. Applying a one-way ANOVA (degree of freedom (DF)=3) to the permeance data an F value of ˜2086 was obtained which is higher than the critical F (rejection region), 3.1; this means that the assumption of all means from the four membrane types to be equal was false (the membranes were in fact different). A two-way ANOVA test (DF=3) was applied to the rejection data and an F value of ˜28.2 was obtained (which is higher than the critical F of ˜2.815) for the different grades suggesting the rejection differences are significant.

It was expected that the higher the polymer Mw the tighter the membrane formed. VICTREX® 450P was the grade with higher M_{w}, 53.33 kDa, but the membrane produced from it (PM-D) was not the tightest; and the membrane produced from VICTREX® 150P, PM-C, was the loosest membrane but the M_{w}, 38.15 kDa, was not the lowest. The values obtained for the polymer grades were within the range reported in literature [13,14]. However, when looking at the viscosity of the dope solutions (Table 1) one can observe that the performance of the different membranes followed a trend: the higher the viscosity the tighter the membrane. In fact, it was expected that polymers with higher M_{w} should result in membrane dope solutions with higher viscosity. Nevertheless, it is important to state that the viscosity of the dope was measured at high polymer concentration (12 wt. %), which means that the dilute solution viscosity theory no longer applies, and at different spindle speeds. Without wishing to be bound by theory, the viscosity of the dope solution could explain the results obtained because higher casting solution viscosities slow down non-solvent in-diffusion and demixing is delayed, resulting in membranes with thicker and denser skin-layers and sublayers with lower porosities [15]

### Performance in DMF

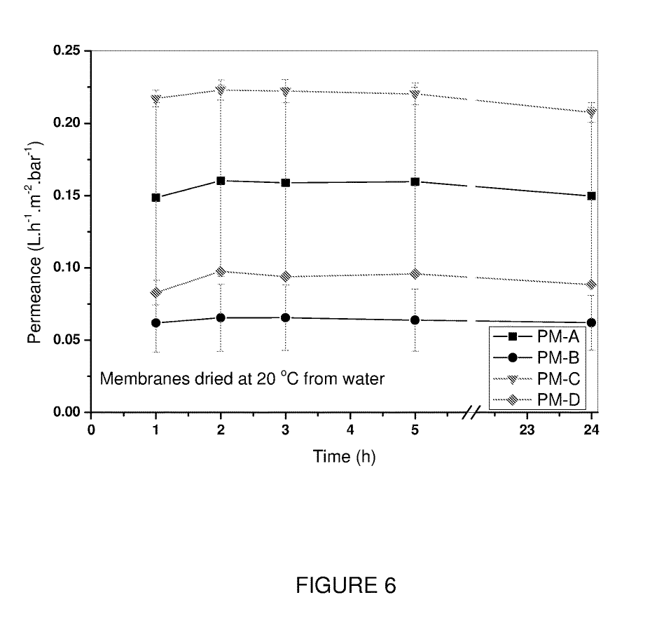

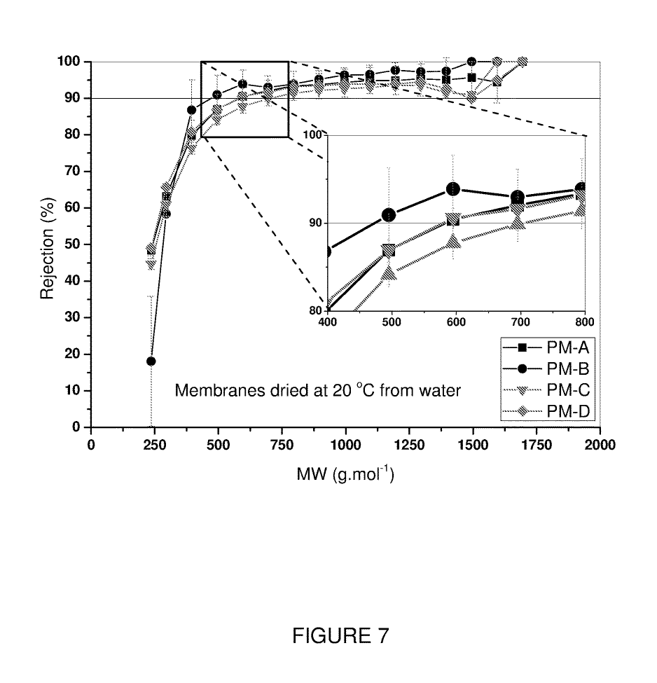

The membranes identified in Table 1 were tested in DMF alongside PS in order to determine the permeance and the MWCO. By testing in a harsh solvent such as DMF the stability of PEEK was proved. The permeance results can be seen in FIGS. 6 and 7. Comparing with the results from THF, the permeance of all studied membranes decreased because of the higher viscosity of DMF, 0.802 mPa·s, when compared with THF, 0.46 mPa·s [16]. The decrease in permeance was on average 2.3, 3.6, 3.3 and 3.7 times for membranes PM-A, PM-B, PM-C and PM-D, respectively. This result is within agreement with the predictions of the pore flow model where the flux should be inversely proportional to the viscosity of the solvent [15]. PM-C, the lowest grade of VICTREX®, presented the highest permeance with a value around 0.21 L.h⁻¹.m⁻².bar⁻¹ but had a MWCO around 700 g.mol⁻¹; PM-A and PM-D had the same MWCO of around 600 g.mol⁻¹ but different permeances of 0.15 L.h⁻¹.m⁻².bar⁻¹ and 0.09 L.h⁻¹.m⁻².bar⁻¹ respectively. PM-B, the tightest membrane presented a permeance of 0.07 L.h⁻¹.m⁻².bar⁻¹ and a MWCO of around 470 g.mol⁻¹. The ANOVA test (DF=3) was also applied to the DMF data and the F values for permeance and rejection data were ˜1200 and ˜13.8 respectively which were higher than the critical F values, ˜3.1 and ˜2.8 respectively (rejection region).

### Example 3

### SEM Analysis

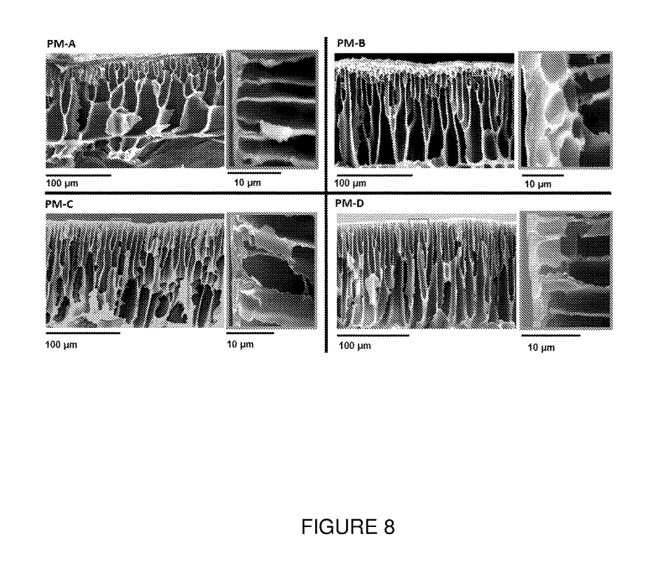

In spite of the different performances in terms of permeance and MWCO, a comparison of the cross-sections of the membranes of Table 1 using SEM did not seem to show any obvious differences (FIG. 8): the membranes presented an asymmetric structure with finger-like structures (macrovoids). However, when observed at higher magnification the differences in terms of performance could be related to the top layer (separating layer) variations. Membranes PM-A, PM-C and PM-D presented (on average) a separation layer with a thickness of 1.5 μm, 1.67 μm and 1.82 μm respectively whereas PM-B presented a separation layer (on average) with a thickness of 3.87 μm. Much thicker separation layer could be the reason for PM-B to be the tightest membrane. In addition, this is in accordance with previous studies suggesting that higher casting solution viscosities slow down non-solvent in-diffusion and demixing is delayed, resulting in membranes with thicker and denser skin-layers and sublayers with lower porosities [15]

### Example 4

### Effect of Degree of Sulphonation on Membrane Performance

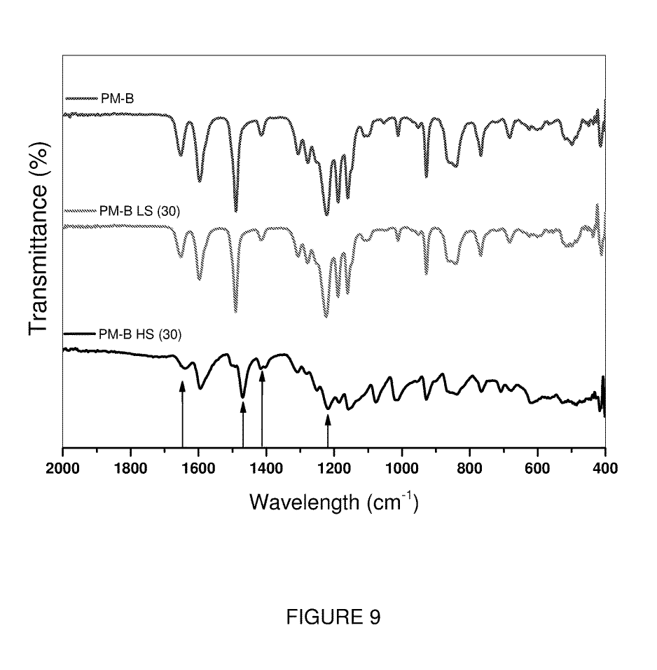

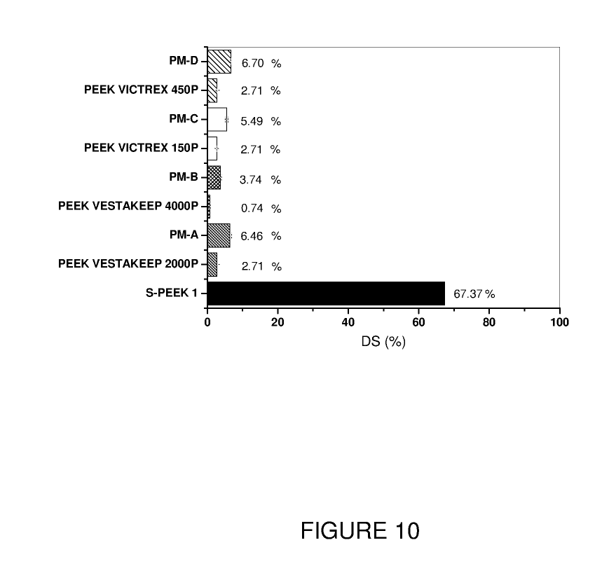

In order to prove the low-sulphonation level of the PEEK membranes of the invention, and hence their stability, it was necessary to determine the DS using elemental microanalysis. Initially attempts were made to use FTIR as a simpler and faster method for DS analysis as suggested by Loy and Sinha [17]. These authors [17], used FTIR to establish a correlation between the ratio of 1492 cm⁻¹:1472 cm⁻¹ absorption peaks and the DS (%). However, no visible split in the peak around the 1490-1470 cm⁻¹ region was observed in our samples making it impossible to use the same correlation (see FIG. 9). In addition, it is also important to mention that the above correlation was obtained for DS in the range of 50 to 80% (which would narrow its extrapolation for lower or higher DS). As a comparison the polymeric powder was also analysed in terms of sulphur content in order to verify the extent of sulphonation from the raw powder. The polymer powder for the different grades showed similar DS of around 2.71% except PEEK VESTAKEEP 4000P which presented a DS of 0.74%. This very low DS for the different PEEK polymer grades might be residual sulphur of diphenyl sulphone used as solvent in polymerization [18]. All produced membranes had a DS in the range of 3.7 to 6.7%, PM-B had the lowest at 3.74% (FIG. 10); for membranes PM-A, PM-C and PM-D the DS doubled, whereas for PM-B the increase in the DS was around five times. The low DS for the membranes of the invention was in accordance with their stability in THF and DMF.

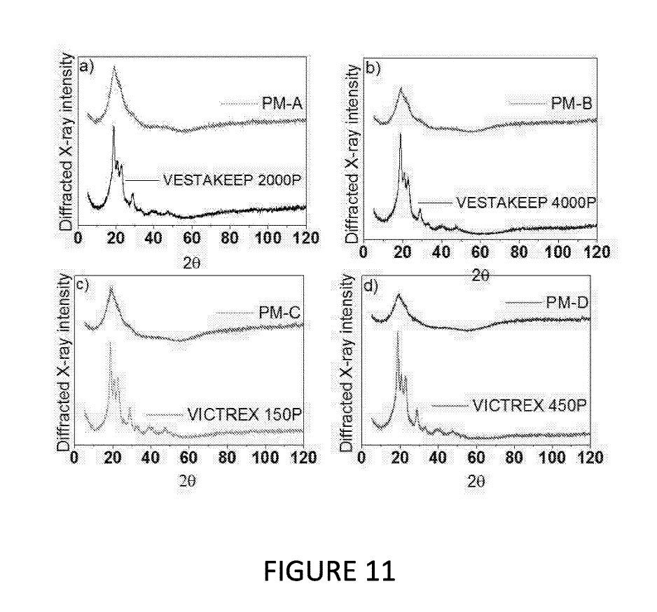

The DS for the different membranes of the invention is very low (between 3-6%) and it does not affect the membrane stability in DMF and THF. However, it seems to partially change the crystallinity of PEEK as can be seen from the XRD spectra shown in FIG. 11. PEEK in its native form is semi-crystalline, with an orthorhombic structure (for the crystal structure) and four main diffraction peaks in the XRD patterns, i.e. (110), (111), (200) and (211) [19,20]. Comparing the XRD patterns between the PEEK polymer grades and the corresponding membranes, the four distinct peaks present initially in the powder somewhat disappeared in the corresponding membrane. This fact is related to a decrease in crystallinity and means that even though the DS was very low for all membranes a loss of crystallinity was observed due to the polymer processing steps—i.e. solubilisation in a 3:1 wt. % mixture of MSA and SA, casting and drying.

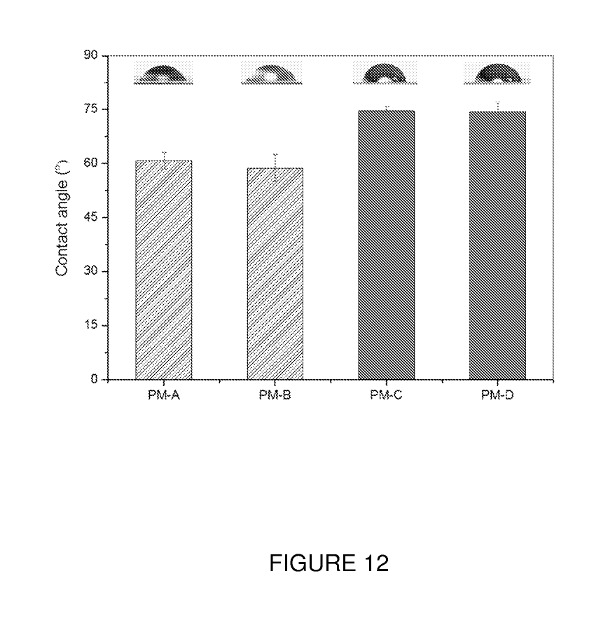

Another change observed was the difference in contact angle when comparing PEEK membranes under study and the original PEEK material. The VICTREX® membranes PM-C and PM-D had higher contact angles, both around 75°, than the VESTAKEEP® membranes, 60° (FIG. 12). PEEK material in its native form has a contact angle of around 80° [21]. This decrease in the contact angle from the original material to the membrane could be related to the DS that despite being very low could slightly change the membrane contact angle; the higher the DS the more hydrophilic the membrane becomes. However this may not be the only factor affecting contact angle, since PM-A and PM-D have similar DS but different contact angles

Membrane PM-B was the tightest membrane produced. Attempts were therefore made at optimising its production and to manipulate separation performance. Initially, the effect of MSA and SA on DS of membranes was investigated. PM-B dope solutions were prepared in three different ways: i) using MSA:SA 3:1 (as described in Example 1); ii) using methane sulfonic acid (MSA) and dichloromethane (DCM) (to help dissolution of the polymer), designated by PM-B LS (low sulphonation); and iii) using only SA, designated by PM-B HS (high sulphonation). Table 2 below shows the composition of the dope solutions:

TABLE 2
PEEK nanofiltration membranes of the invention

| | |
|---|---|
| Membrane | Polymer dope composition (wt. %) |

| code | PEEK | MSA | SA | DCM |
|---|---|---|---|---|
| PM-B | 12 | 66 | 22 | 0 |
| PM-B LS | 12 | 86 | 0 | 2 |
| PM-B HS | 12 | 0 | 88 | 0 |

All membranes were cast twice, once from a dope solution kept for 3 days at 20° C. (denoted “3”) and the second time from a dope kept for 30 days at 20° C. (denoted “30”) in order to test the influence of reaction time on the DS.

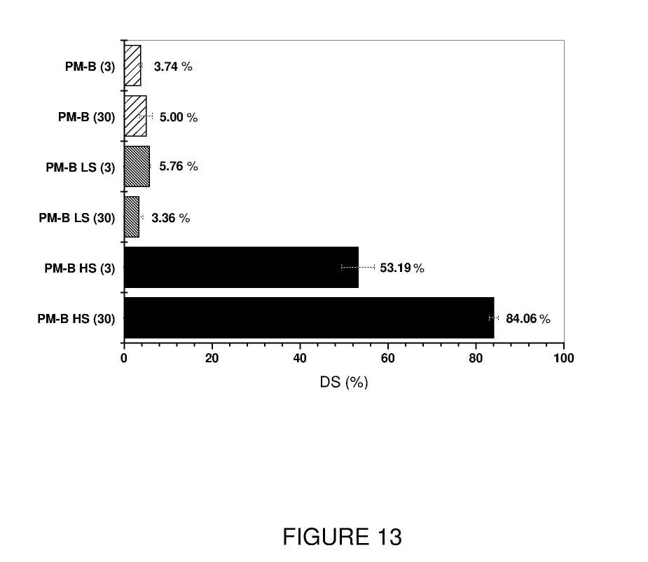

It was expected that the DS would increase from PM-B LS to PM-B HS and that DS of PM-B should be similar to that of PM-B LS. The results from ATR-FTIR for the prepared membranes are shown in FIG. 9 and from the spectra one can see that PM-B and PM-B LS (30) had a very similar spectrum whereas PM-B HS (30) had a less defined spectrum in the range of 400-1200 cm⁻¹. The results of DS (%) from elemental analysis can be seen in FIG. 13 PM-B LS (3) (cast after 3 days) and PM-B LS (30) (cast after 30 days), which represent two different pieces of membranes prepared from different dopes, showed a DS of 5.76% and 3.36%, respectively, which suggests that in the presence of MSA there may be some sulphonation reaction, despite the fact that MSA is not considered to be a sulphonating agent [22]. In addition, it was expected that the DS should be higher for PM-B LS (30) but results presented appear to indicate otherwise. Without wishing to be bound by theory, this may be related to the fact that not all MSA was removed completely from the smallest nodules while washing the membrane with DI water. PM-B (3) and PM-B (30), had a similar DS of 3.74% and 5.00%, respectively; this small increase of 1.3% in the DS is in accordance with previous studies where temperature has a far more pronounced effect on the DS when compared with the time of reaction [18]. PM-B HS (3) and PM-B HS (30), which were prepared with sulphuric acid as solvent (see Table 2) had a higher difference in terms of DS, 53.19% versus 84.06%. This increase in the DS is related to the reactivity of SA over time with PEEK, which, unlike MSA, is considered to be a strong sulphonating agent.

The DS affects the performance of PEEK membrane in terms of solubility characteristics in different solvents. A solubility test was performed in order to verify the solubility of the three different membranes in six solvents (see Table 3). Both PM-B and PM-B LS showed the same behaviour regardless of the time of casting (3 or 30 days), being insoluble in all solvents tested. As for PM-B HS, the high DS greatly affected its stability. For PM-B HS (30) which presented the highest DS, 84.06%, the membrane was completely degraded in DMF, THF and EtOH. In acetone the membrane showed some swelling before complete disintegration and in DCM and n-hexane it proved to be stable. As for PM-B HS (3) the membrane was insoluble in all solvents except for DMF where it immediately dissolved.

TABLE 3
Solubility of PEEK films (at 20°
C. for 7 days) in different solvents)

| | PM-B (3) | PM-B LS (3) | | |
|---|---|---|---|---|
| Solvent | PM-B (30) | PM-B LS (30) | PM-B HS (3) | PM-B HS (30) |
| DMF | Insoluble | Insoluble | Soluble | Soluble |
| THF | Insoluble | Insoluble | Insoluble | Soluble |
| EtOH | Insoluble | Insoluble | Insoluble | Soluble |
| Acetone | Insoluble | Insoluble | Insoluble | Swollen/ |
| | | | | Soluble |
| n-hexane | Insoluble | Insoluble | Insoluble | Insoluble |
| DCM | Insoluble | Insoluble | Insoluble | Insoluble |

The membranes PM-B LS and PM-B HS were not tested in terms of performance (permeance and rejection) because PM-B LS (3) and PM-B LS (30) were not uniform dope solutions and consequently a uniform membrane was not produced—DCM is not miscible with water and some irregularities could be observed on the membrane surface—and PM-B HS (3) and PM-B HS (30) after drying became very brittle; in addition, and as mentioned before, they were not resistant in DMF.

PM-B (3) was also tested in terms of solubility in acidic and basic solutions with different concentrations (see Table 4). Over a period of 4 months negligible weight loss (<1%) was observed. Even in a 2M H₂SO₄ (one of the acids used as solvent for dissolving the polymer) the membrane presented great resistance with only a weight loss of 0.65%.

TABLE 4
Weight loss (%) of PM-B (3) for a period of for 4 months
(at 20° C.) in different acidic and basic solutions.

| Acid/Base | Concentration (M) | Mass loss (%) |
|---|---|---|
| H₂SO₄ | 2 | 0.65 |
| HCl | 2 | 0.28 |
| KOH | 2 | 0.68 |
| NaOH | 25 | 0.21 |
| MEA | 16.4 | 0.00 |

### Example 5

### Control of Pore Collapsing for MWCO Tuning

### The Effect of Polymer Concentration and Drying Temperature

In order to improve the permeance—without compromising the MWCO—a study on polymer concentration (8 wt. % to 12 wt. %) and drying temperatures (20° C., 40° C., 80° C. and 120° C.) was performed in order to determine their influence on membrane performance (see Table 5 below).

TABLE 5
Summary of PEEK membranes PM-B prepared from dopes with
different polymer concentrations (8 wt. %, 10 wt. % and
12 wt. %) and dried from water at different temperatures.
The viscosity (Pa · s) of the membrane dope solution
as well as the spindle speed (rpm) used are also presented.

| | Polymer | | | |
|---|---|---|---|---|
| | concen- | | Spindle | Drying |
| Membrane | tration | Viscosity | speed | temperature |
| code | (wt. %) | (Pa · s) | (rpm) | (° C.) |
| PM-B 8 wt % 20 C. | 8 | 7.72 ± 0.04 | 10 | 20° C. |
| PM-B 8 wt % 40 C. | | | | 40° C. |
| PM-B 8 wt % 80 C. | | | | 80° C. |
| PM-B 8 wt % 120 C. | | | | 120° C. |
| PM-B 10 wt % 20 C. | 10 | 25.46 ± 1.86 | 3 | 20° C. |
| PM-B 10 wt % 40 C. | | | | 40° C. |
| PM-B 10 wt % 80 C. | | | | 80° C. |
| PM-B 10 wt % 120 C. | | | | 120° C. |
| PM-B 12 wt % 20 C. | 12 | 58.03 ± 1.58 | 1 | 20° C. |
| PM-B 12 wt % 40 C. | | | | 40° C. |
| PM-B 12 wt % 80 C. | | | | 80° C. |
| PM-B 12 wt % 120 C. | | | | 120° C. |

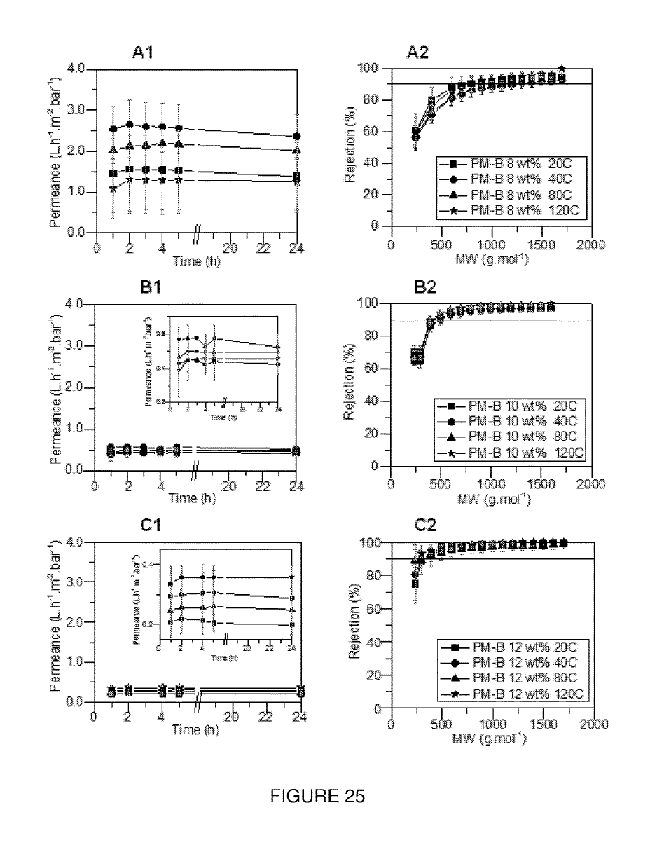

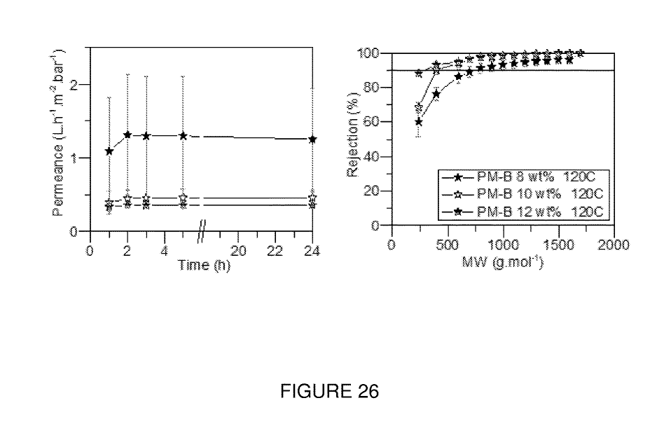

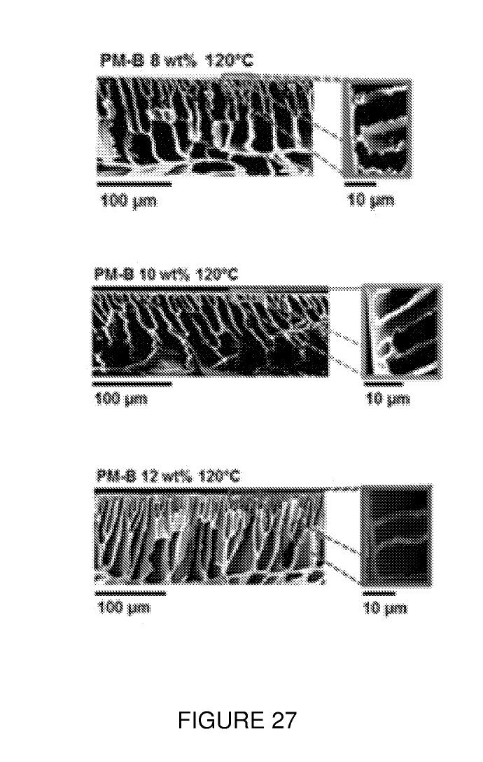

The membranes with lower polymer concentration (8 wt. %) presented higher permeance values, in the range of 1.25 L.h⁻¹.m⁻².bar⁻¹ to 2.30 L.h⁻¹.m⁻².bar⁻¹, and a MWCO in the range of 795 g.mol⁻¹ to 1295 g.mol⁻¹ (FIG. 25). The membranes dried at 20° C. and 120° C. were the tightest ones and with lower permeance whereas the ones dried at 40° C. and 80° C. presented a higher MWCO and higher permeance, i.e., there was no trend as a function of the temperature. Both higher polymer concentrations—10 wt. % and 12 wt. %—presented lower permeances and lower MWCO (tighter membranes). The permeance of the membranes prepared with 10 wt. % of polymer was in the range of 0.42 L.h⁻¹.m⁻².bar⁻¹ to 0.52 L.h⁻¹.m⁻².bar⁻¹ and the MWCO was in the range of 395 g.mol⁻¹ to 495 g.mol⁻¹. As for the 12 wt. % membranes, the permeance was in the range of 0.18 L.h⁻¹.m⁻².bar⁻¹ to 0.40 L.h⁻¹.m⁻².bar⁻¹ and the MWCO was in the range of 295 g.mol⁻¹ to 395 g.mol⁻¹. Looking at the results from the different membranes dried at 120° C. (FIG. 26) it is clear that the polymer concentration has a higher influence on the membrane performance than the drying temperature on membranes of the same polymer concentration (FIG. 25). The difference is more noticeable between the 8 wt. % and the 10 wt. % than between the 10 wt. % and the 12 wt. %. This may be explained by the viscosity of the dope solution because the 8 wt. % polymer dope solution had 3.30 times and 7.51 times lower viscosity than the 10 wt. % polymer dope and 12 wt. % polymer dope respectively; the difference in viscosity between 10 wt. % polymer dope solution and 12 wt. % polymer dope solution was only 2.28 times. The viscosity of the dope solution (Table 5) could explain the results obtained because higher casting solution viscosities slow down non-solvent in-diffusion and demixing is delayed, resulting in membranes with thicker and denser skin-layers and sublayers with lower porosities. From the SEM images (FIG. 27) it was found that membranes PM-B 8 wt. % 120 C had a thinner separation layer of approximately 2.0 μm whereas for membranes with higher polymer concentration the active layer had a thickness of approximately 2.9 μm.

Given the fact that the membranes with a polymer concentration of 12 wt. % presented the lower MWCO, all subsequent studies were performed using this polymer concentration.

### The Effect of Drying Solvent

The final membrane pore size is greatly influenced by the surface tension of the solvent filling membrane pores prior to drying. To investigate this effect on the PEEK membranes a solvent exchange from water to IPA, MeOH, EtOH, n-hexane, acetone or THF was performed after the phase inversion process in order to change the surface tension and possibly achieve different extents of collapsing in the polymer nodular structure. Water has a surface tension of 72.8 mN.m⁻¹ while the remaining solvents have similar (and much lower) values of surface tension in the range of 18.4 mN.m⁻¹ to 26.4 mN.m⁻¹ (Table 7).

The contact angle water/PEEK was measured to be 60°. We were unable to measure contact angles for the other solvents, since the droplet spread instantaneously, thus these contact angles were assumed as 0°. Therefore, and according to the theory presented by Brown [24], membranes immersed in IPA, MeOH, EtOH should give similar MWCO because of the similarity in surface tension; n-hexane should present higher MWCO (looser membranes) because it has the lowest surface tension and acetone and THF should give tighter membranes (excluding the ones dried from water). According to this method F_{c} should be higher for water at any given pore radius and therefore, pore collapse in water is expected to occur at a much higher extent. As a result, membranes dried from all the other solvents should be looser than membranes dried from water with the following order (from lower MWCO to higher MWCO membrane): water<THF<acetone<MeOH<EtOH<IPA<n-hexane. Together with the solvent type the effect of drying temperature on the permeance and on the MWCO was also studied. The membranes produced are presented in Tables 6 and 7.

TABLE 6
PEEK membranes based on PM-B prepared from different
dope solutions and with different post-treatments.

| Membrane | Solvent | Drying temperature |
|---|---|---|
| code | exchange | (° C.) |
| PM-B1.1 | No/Water | 20° C. |
| PM-B1.2 | No/Water | 40° C. |
| PM-B1.3 | No/Water | 80° C. |
| PM-B1.4 | No/Water | 100° C. |
| PM-B1.5 | No/Water | 120° C. |
| PM-B2.1 | Yes/IPA | 20° C. |
| PM-B2.2 | Yes/IPA | 40° C. |
| PM-B2.3 | Yes/IPA | 80° C. |
| PM-B2.4 | Yes/IPA | 100° C. |
| PM-B2.5 | Yes/IPA | 120° C. |
| PM-B3.1 | Yes/MeOH | 20° C. |
| PM-B3.2 | Yes/MeOH | 40° C. |
| PM-B3.3 | Yes/MeOH | 80° C. |
| PM-B3.4 | Yes/MeOH | 100° C. |
| PM-B3.5 | Yes/MeOH | 120° C. |
| PM-B4.1 | Yes/EtOH | 20° C. |
| PM-B4.2 | Yes/EtOH | 40° C. |
| PM-B4.3 | Yes/EtOH | 80° C. |
| PM-B4.5 | Yes/EtOH | 120° C. |
| PM-B5.1 | Yes/n-Hexane | 20° C. |
| PM-B5.2 | Yes/n-Hexane | 40° C. |
| PM-B5.3 | Yes/n-Hexane | 80° C. |
| PM-B5.5 | Yes/n-Hexane | 120° C. |
| PM-B6.1 | Yes/Acetone | 20° C. |
| PM-B6.2 | Yes/Acetone | 40° C. |
| PM-B6.3 | Yes/Acetone | 80° C. |
| PM-B6.5 | Yes/Acetone | 120° C. |

TABLE 7
Summary of PEEK membranes PM-B 12 wt % prepared from different dopes
and with different post-treatments. These membranes were used to test the
influence of solvent exchange and drying temperature on permeance and
rejection. In addition, properties of the solvents used for the solvent
exchange: surface tension (mN · m⁻¹), MW (g · mol⁻¹), boiling point (° C.),
vapour pressure (kPa) and molar volume (cm³ · mol⁻¹) are provided.
All properties listed were obtained from ²⁴ at 20° C. and 1 bar.

| | | Solvent properties | | | | |
|---|---|---|---|---|---|---|
| | | Drying | Surface | Boiling | Vapour | Molar |
| Membrane | Solvent | temperature | tension | point | pressure | volume |
| code | exchange | (° C.) | (mN · m⁻¹) | (° C.) | (kPa) | (cm³ · mol⁻¹) |
| PM-B1.1 | No/Water | 20° C. | 72.8 | 100 | 2.33 | 18.0 |
| PM-B1.2 | No/Water | 40° C. | | | | |
| PM-B1.3 | No/Water | 80° C. | | | | |
| PM-B1.4 | No/Water | 120° C. | | | | |
| PM-B2.1 | Yes/MeOH | 20° C. | 22.6 | 64 | 16.93 | 40.6 |
| PM-B2.2 | Yes/MeOH | 40° C. | | | | |
| PM-B2.3 | Yes/MeOH | 80° C. | | | | |
| PM-B2.4 | Yes/MeOH | 120° C. | | | | |
| PM-B3.1 | Yes/EtOH | 20° C. | 22.3 | 78 | 5.95 | 58.6 |
| PM-B3.2 | Yes/EtOH | 40° C. | | | | |
| PM-B3.3 | Yes/EtOH | 80° C. | | | | |
| PM-B3.4 | Yes/EtOH | 120° C. | | | | |
| PM-B4.1 | Yes/IPA | 20° C. | 21.7 | 82 | 4.10 | 76.9 |
| PM-B4.2 | Yes/IPA | 40° C. | | | | |
| PM-B4.3 | Yes/IPA | 80° C. | | | | |
| PM-B4.4 | Yes/IPA | 120° C. | | | | |
| PM-B5.1 | Yes/Acetone | 20° C. | 23.3 | 56 | 30.80 | 73.8 |
| PM-B5.2 | Yes/Acetone | 40° C. | | | | |
| PM-B5.3 | Yes/Acetone | 80° C. | | | | |
| PM-B5.4 | Yes/Acetone | 120° C. | | | | |
| PM-B6.1 | Yes/THF | 20° C. | 26.4 | 66 | 21.60 | 81.9 |
| PM-B6.2 | Yes/THF | 40° C. | | | | |
| PM-B6.3 | Yes/THF | 80° C. | | | | |
| PM-B6.4 | Yes/THF | 120° C. | | | | |
| PM-B7.1 | Yes/IPA/n-hexane | 20° C. | 18.4 | 69 | 20.17 | 131.4 |
| PM-B7.2 | Yes/IPA/n-hexane | 40° C. | | | | |
| PM-B7.3 | Yes/IPA/n-hexane | 80° C. | | | | |
| PM-B7.4 | Yes/IPA/n-hexane | 120° C. | | | | |

### Results Presented in Table 6

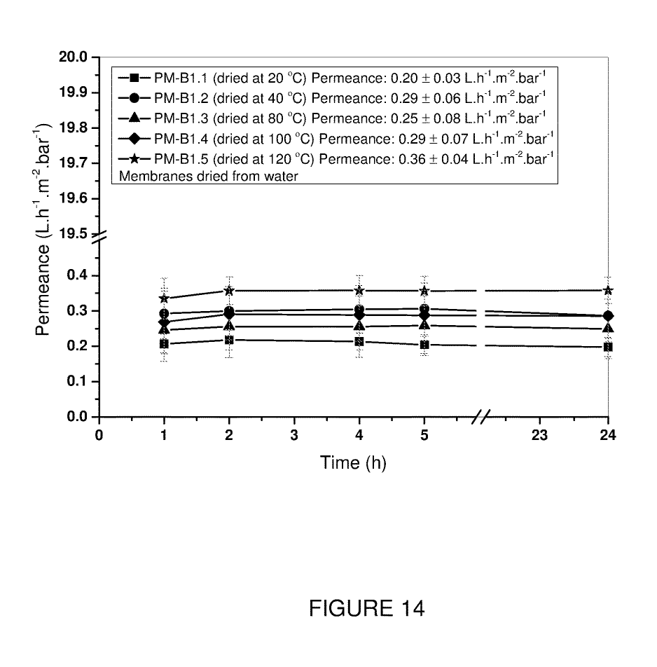

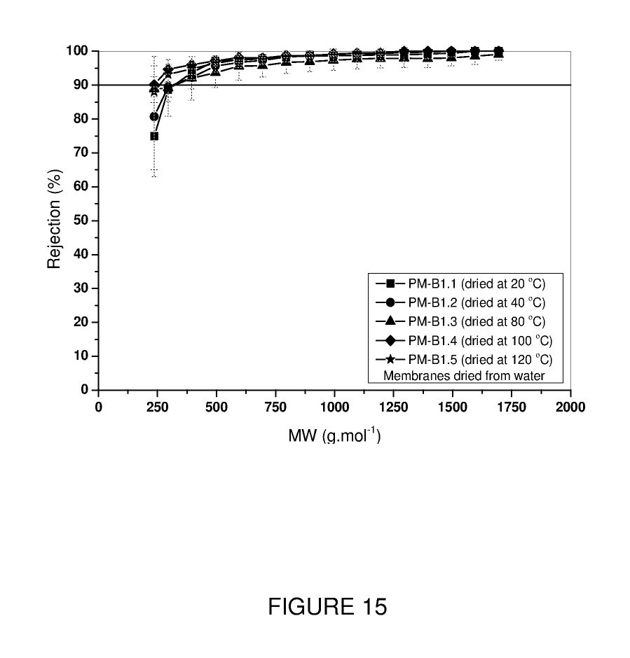

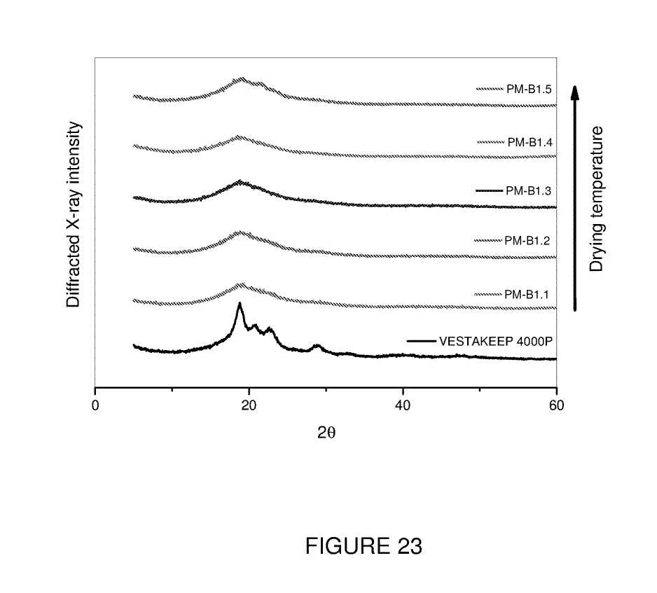

Having regard to the data presented in Table 6, and referring to FIG. 14, it is observed that the permeance for all membranes dried from water at different temperatures had very similar values, ranging from 0.20 to 0.36 L.h⁻¹.m⁻².bar⁻¹. The temperature did not have great influence on the permeance and there was no trend. The membrane with the higher permeance was PM-B1.5, which was heated at 120° C. However, for the MWCO (FIG. 15) the temperature had a more pronounced effect for the heating temperatures of 100° C. and 120° C., as could be seen for the tighter membranes produced (MWCO of around 236 g.mol⁻¹). Without wishing to be bound by theory, this fact could be attributed to residual water that might have been still retained in the smallest pores existing in the membrane and that above 100° C. (boiling point of water at 1 bar) all residual water may have been completely removed. The effect of temperature on the crystallinity of the membranes dried from water was also determined (FIG. 23). It was clear that from PM-B1.1 (heated at 20° C.) to PM-B1.4 (heated at 100° C.) there was no change in the membrane crystallinity (only one broad peak at ˜18°), but for PM-B1.5 (dried at 120° C.) another peak at ˜21° was detected. This result showed a slight increase in crystallinity when approaching the T_{g} of PEEK. A membrane heated at 140° C. was also prepared. It showed THF permeance of 0.04 L.h⁻¹.m⁻².bar⁻¹ but no rejection in the nanofiltration range (data not shown), possibly due to defects originated from the partial melting with the backing material.

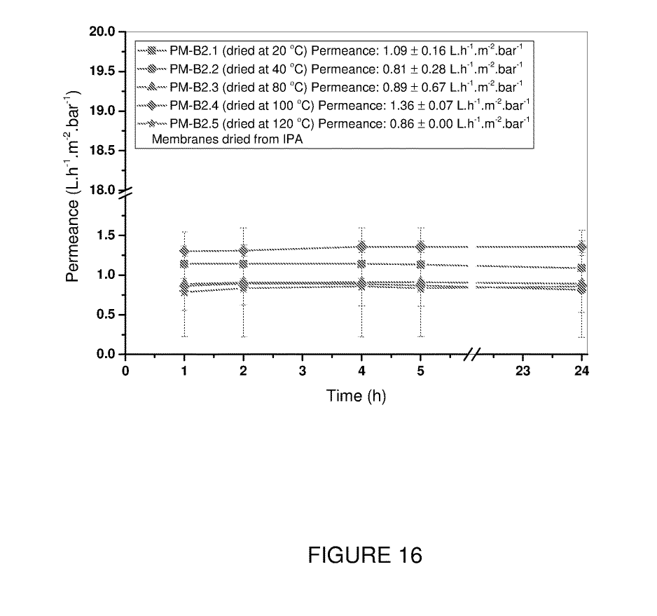

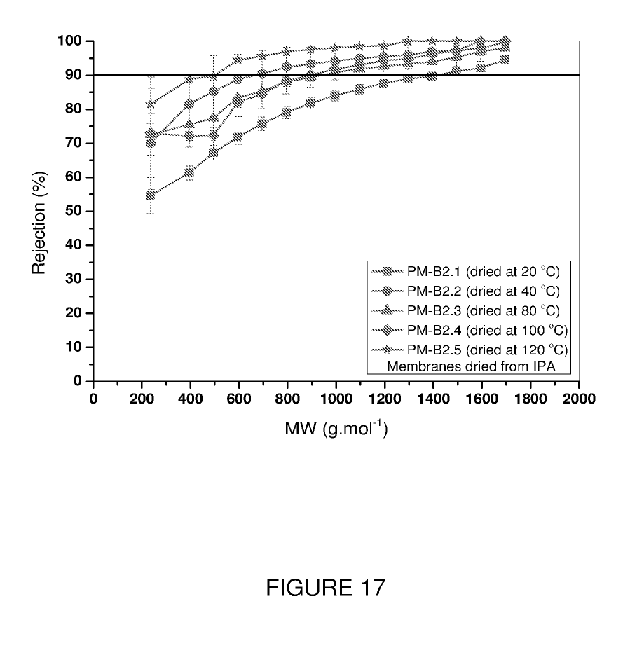

For membranes dried from IPA, it can be observed that the permeance was on average 3.5 times higher than the membranes dried from water. Nevertheless, and similar to membranes dried from water, the permeance did not seem to follow any trend as a function of temperature (See FIGS. 16 and 17). In fact, the values of permeance ranged from 0.86 L.h⁻¹.m⁻².bar⁻¹ (PM-B2.5, heated at 120° C.) to 1.4 L.h⁻¹.m⁻².bar⁻¹ (PM-B2.4 heated at 100° C.). For the temperatures of 40° C. to 100° C. the rejection values were quite similar. The membrane with the lowest permeance (PM-B2.5) presented the lowest MWCO and its value was around 500 g.mol⁻¹. For membrane PM-B2.1 (which demonstrated a high permeance) the MWCO was in the upper range of the nanofiltration region, with a value around 1400 g.mol⁻¹. In the case of IPA, this solvent has a lower boiling point than water (82.24° C. at 1 bar) which allows for more solvent to be removed from the membranes pores possibly at a faster rate; therefore, the heating temperature had more pronounced effect on the properties of the membrane when compared with water.

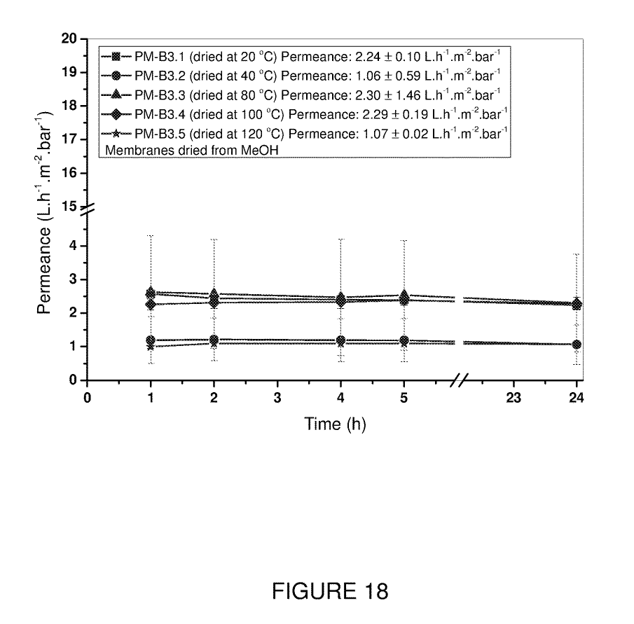

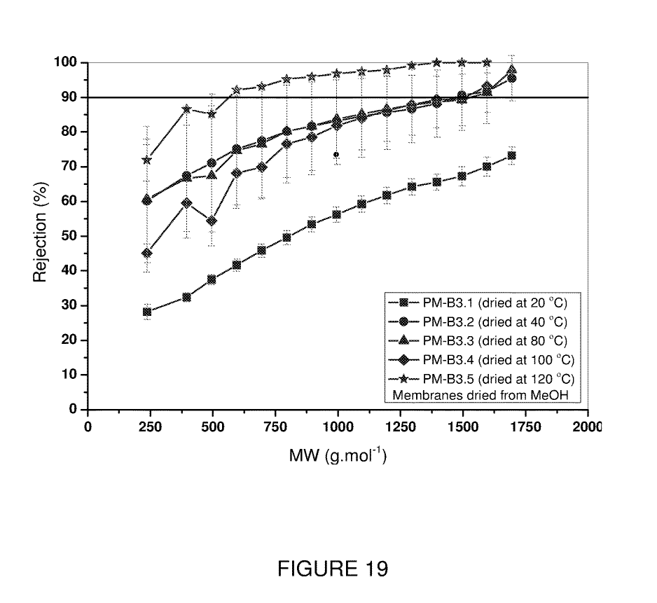

The membranes dried from MeOH (FIGS. 18 and 19) followed the same tendency as the ones dried from IPA, i.e., the heating temperature did not have a great influence on the permeance but it had on the MWCO. The range of values for permeance varied more with the temperature ranging from 1.07 L.h⁻¹.m⁻².bar⁻¹ (PM-B3.5) to 2.3 L.h⁻¹.m⁻².bar⁻¹ (PM-B3.3 and PM-B3.4). From the rejection data (FIG. 19) it is clear that the heating temperature has a greater effect on the MWCO, i.e, the higher the heating temperature the tighter the membrane with exception of membrane PM-B3.4, dried at 100° C. As was observed for IPA, for the temperature range 40° C. to 100° C. the rejection values were in fact quite similar, although the variability of the membranes PM-B3.2 and PM-B3.3 make it difficult to confirm this result. The loosest membrane, PM-B3.1, has a MWCO beyond the nanofiltration range. Membranes PM-B3.2, PM-B3.3 and PM-B3.4 presented a MWCO of around 1300 g.mol⁻¹, although the standard deviation was not narrow enough to validate the result. The tightest membrane, PM-B3.5, had a MWCO around 600 g.mol⁻¹. In this case, the temperature had a much greater effect because the boiling point of MeOH is the lowest of the three solvents: 64° C. at 1 bar and presumably it could be easily removed from the membrane pores.

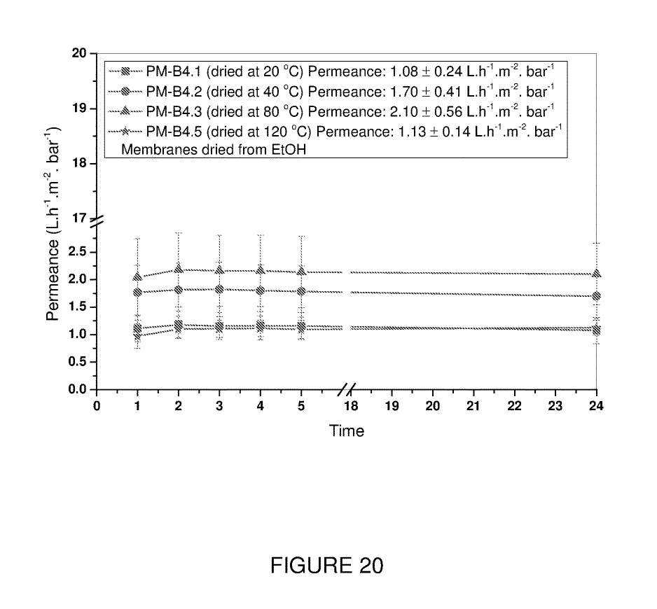

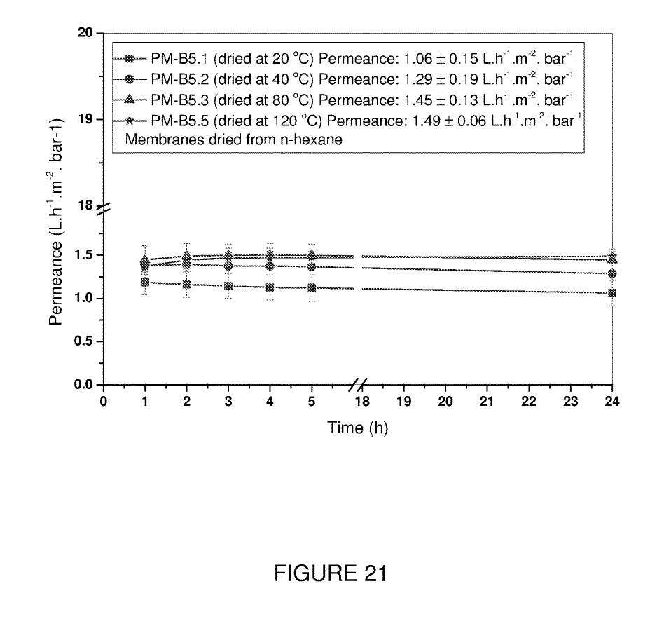

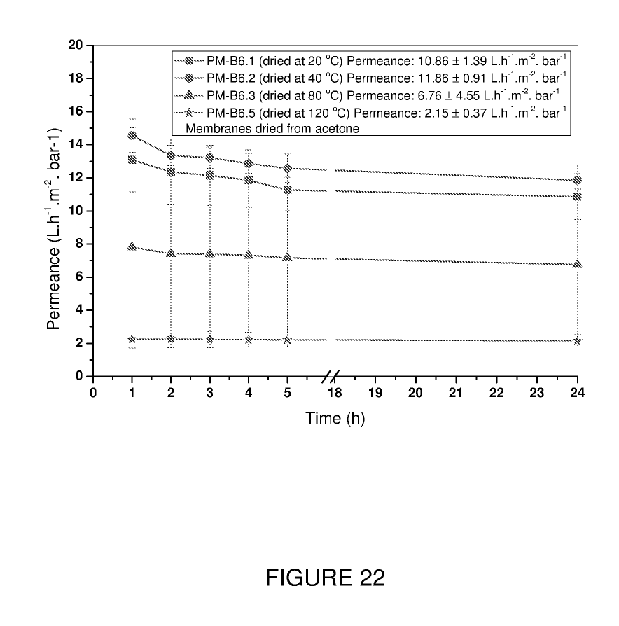

The permeance data for membranes heated and dried from ethanol, n-hexane and acetone are shown in FIGS. 20, 21 and 22 respectively.

### Results Presented in Table 7

Having regard to the data presented in Table 7, the permeance for all membranes dried from water at different temperatures had very similar values, ranging from 0.20 to 0.36 L.h⁻¹.m⁻².bar⁻¹. The temperature did not have great influence on the permeance and the expected trend, i.e., the higher the drying temperature the lower the permeance, was not observed. This fact could be attributed to residual water that might still have been retained in the smallest pores existing in the membrane (thus obstructing solvent permeance) and that above 100° C. (boiling point of water at 1 bar) all residual water may have been completely removed (hence higher permeance).

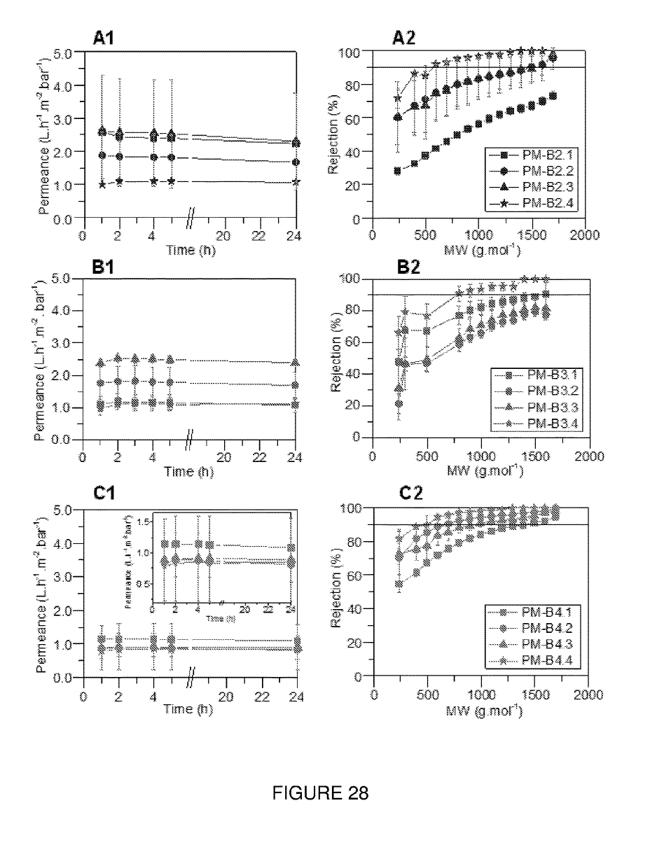

As for membranes dried from the alcohols, it is observed that for MeOH (FIGS. 28A1 and A2), and similar to membranes dried from water, the permeance did not seem to follow any trend as a function of temperature. The permeance values varied more with the temperature ranging from 1.07 L.h⁻¹.m⁻².bar⁻¹ (PM-B2.4) to 2.3 L.h⁻¹.m⁻².bar⁻¹ (PM-B2.3). From the rejection data (FIG. 28 A2) it is clear that the drying temperature has a greater effect on the MWCO, i.e, the higher the drying temperature the tighter the membrane. For the temperatures of 40° C. and 80° C. the rejection values were in fact quite similar, although the variability of the membranes PM-B2.2 and PM-B2.3 makes it difficult to confirm this result. The loosest membrane, PM-B2.1, has a MWCO beyond the NF range. Membranes PM-B2.2 and PM-B2.3 presented a MWCO of around 1300 g.mol⁻¹ but the standard deviation was not narrow enough to validate the result. The tightest membrane, PM-B2.4, had a MWCO around 600 g.mol⁻¹.

For the membranes dried from EtOH (FIGS. 28B1 and B2) the temperature had a visible influence on the permeance and on the MWCO and a trend in rejection as a function of temperature can be observed if excluding the membrane PM-B3.1. The range of values for permeance varied from 1.07 L.h⁻¹.m⁻².bar⁻¹ (PM-B3.1) to 2.1 L.h⁻¹.m⁻².bar⁻¹ (PM-B3.3). From the rejection data (FIG. 28B2) one can observe that for the temperatures of 40° C. and 80° C. the rejection values were in fact quite similar and both had a relatively high MWCO; membrane PM-B3.1 presented a MWCO of around 1595 g.mol⁻¹; and the tightest membrane, PM-B3.4, had a MWCO around 795 g.mol⁻¹.

For the membranes dried from IPA (FIGS. 28C1 and C2) the permeance was in average 3.5 times higher than the membranes dried from water. Nevertheless, the permeance did not seem to follow any trend as a function of temperature. In fact, the values of permeance ranged from 0.81 L.h⁻¹.m⁻².bar⁻¹ (PM-B4.2, dried at 40° C.) to 1.36 L.h⁻¹.m⁻².bar¹ (PM-B4.4 dried at 20° C.). Analysing the rejection data it could be seen that some trend was observed; the higher the drying temperature the tighter the membrane with the exception of PM-B4.2 (dried at 40° C.). For the temperatures of 40° C. and 80° C. the rejection values were in fact quite similar, although slightly higher for PM-B4.2 (as mentioned before). The membrane with the lowest permeance (PM-B4.4) presented the lowest MWCO and its value was around 500 g.mol⁻¹. As for membrane PM-B4.1 (membrane with a high permeance) the MWCO was in the upper range of NF with a value around 1400 g.mol⁻¹.

In the case of the alcohols, the boiling points of each of the alcohols are lower than the boiling point of water (Table 7) which allows for more solvent to be removed from the membranes pores possibly at a faster rate; therefore, the drying temperature had more pronounced effect on the properties of the membrane when compared with water.

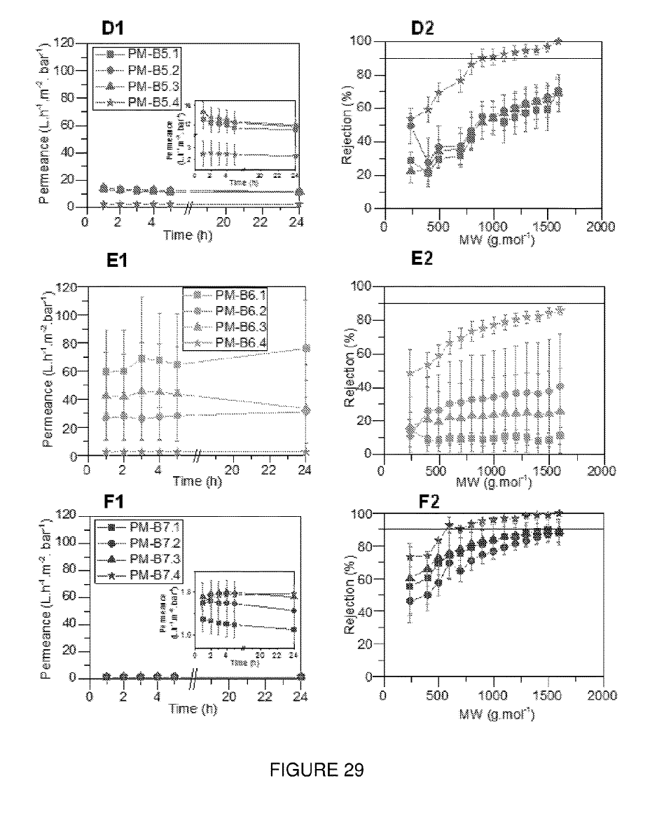

As can be seen in FIGS. 29D and E, membranes dried from acetone and THF were affected to a greater extent by the temperature. For both solvents (acetone and THF), the membranes had similar performances at 20° C. to 80° C. but a substantial difference occurred when dried at 120° C. (FIGS. 29D2 and E2). In the case of acetone, the membranes dried at 120° C. had a permeance of 2.15 L.h⁻¹.m⁻².bar⁻¹ which was in average 4.5 times lower than for any other drying temperature considered; the MWCO was 895 g.mol⁻¹. For the membranes dried from THF in the temperature range of 20° C. to 80° C. the presented standard deviations made it difficult to assess within a confidence interval both permeance and rejection for these temperatures. Nevertheless, for the temperature of 120° C. the membranes presented a permeance of 2.72 L.h⁻¹.m⁻².bar⁻¹ which was in average 28 times lower than PMB-6.1 and 12 times lower than PMB-6.2 and PMB-6.3. This membrane presented a relatively high MWCO but nevertheless from FIG. 29 E2 one can observe that a shift occurred in terms of rejection when comparing PM-B6.4 with the other ones (tightening of the membrane matrix by increasing drying temperature).

For membranes dried from n-hexane the temperature effect was not that pronounced but nevertheless the membranes dried at 120° C. were tighter (MWCO=595 g.mol⁻¹) than the ones dried at other temperatures which had similar performances (MWCO around 1400 g.mol⁻¹). The permeance ranged from 1.06 L.h⁻¹.m⁻².bar⁻¹ to 1.49 L.h⁻¹.m⁻².bar⁻¹. It is also important to point out that membranes dried from n-hexane had two solvent exchanges from water to IPA and then to n-hexane, which may also affect the final membrane.

### Example 7

### High-Temperature Filtrations

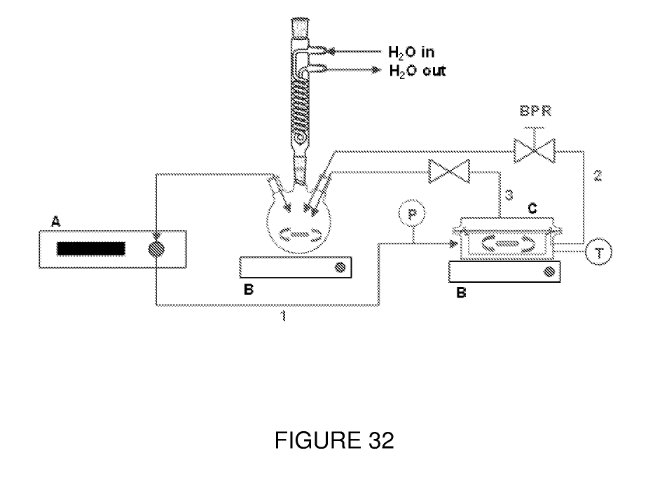

In order to test the membranes a high temperature rig consisting of two cross-flow cells (effective membrane area=51 cm²) in parallel was used (see FIG. 32). In both cross-flow cells, a Gilson HPLC pump (Model 305) provided the flow, set at 9 mL.min⁻¹. The pressure of each cell was controlled using a back-pressure regulator, and a magnetic stirrer was placed inside each cell (stirred at 500 rpm) to maintain a constant hydrodynamic profile. The feed tank volume was 200 mL, and the volume of each cell plus the associated tubing was approximately 100 mL.

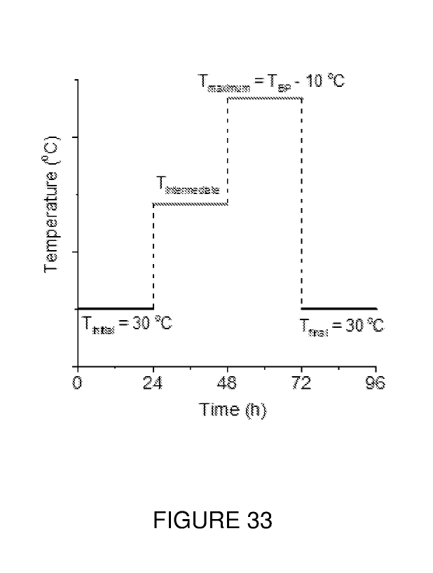

Polystyrene standard solution was poured into the feed reservoir and the system was pressurized again up to 30 bar and the temperature set at 30° C. For each of the solvents the maximum operating temperature was set to be at 5-10 degrees below the boiling point of the corresponding solvent. Each temperature was set constant for 24 h prior to change. After reaching the maximum operating temperature the system was cooled down to 30° C. (see FIG. 33).

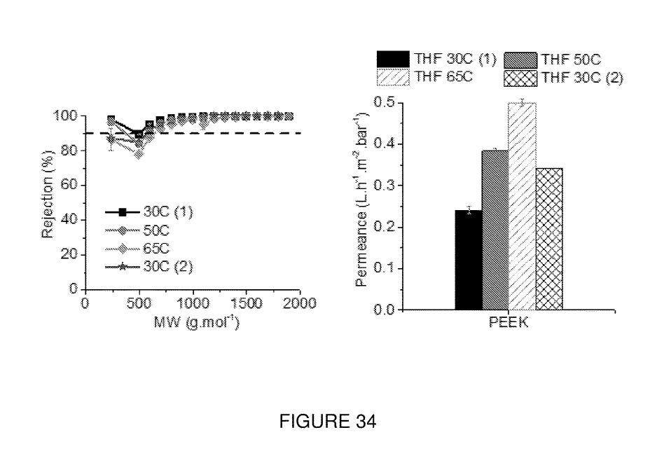

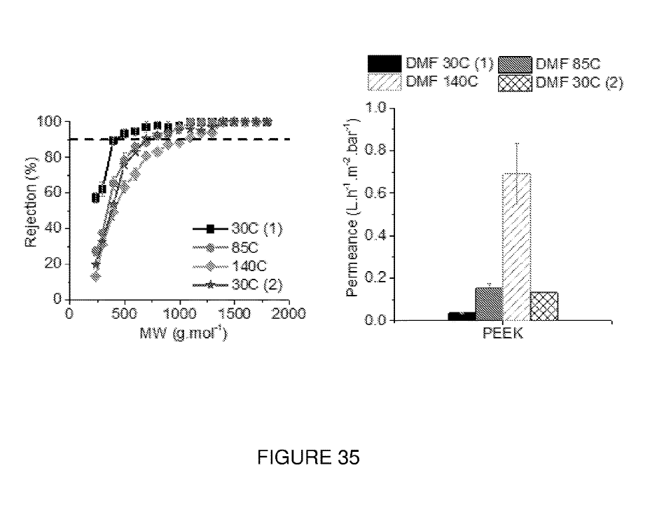

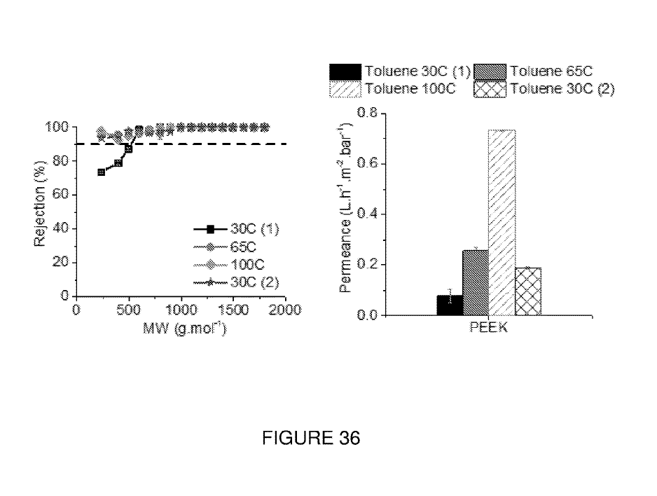

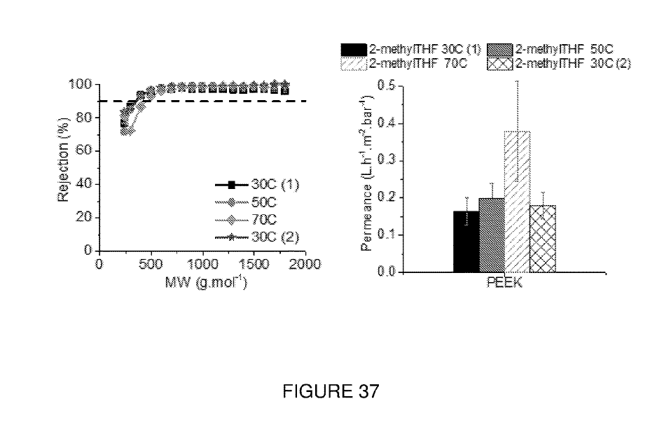

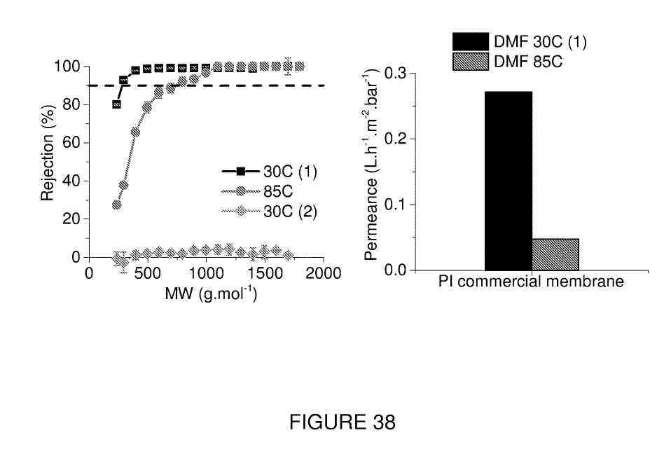

FIGS. 34-37 show the effect of high temperature filtrations on membranes of the invention that were dried from water at 120° C. As a comparative example, FIG. 38 shows the effect of high temperature filtrations on polyimide membranes.

### Example 8

### PEEK Mixed Matrix Membranes

PEEK powder VESTAKEEP® 4000P at a concentration of 12 wt. % and 0, 5, 10, 20, 50 and 100 wt. % (relative to the polymer weight) of graphite or ZrO₂ were dissolved in a mixture of 3:1 wt. % methanesulfonic acid (MSA) and sulphuric acid (SA) by mechanical stirring (IKA RW 20 digital) at 20° C. until complete homogenisation of polymer solution. Prior to casting the polymer solution was left 72-96 hours at 20° C. until complete removal of air bubbles. The membranes were cast using a bench top laboratory casting machine (Elcometer 4340 Automatic Film Applicator) with a blade film applicator (Elcometer 3700) set at 250 μm thickness. The polymer dope solution obtained was poured into the blade and cast on a polypropylene support (Novatex 2471, Freudenberg Filtration Technologies Germany) with a transverse speed of 0.5 cm.s-1. Following this, the membranes were immersed in deionised (D1) water precipitation bath at 20° C.; the water in the bath was changed several times until pH 6-7. Finally, the membranes were left to dry at 20 or 120° C.

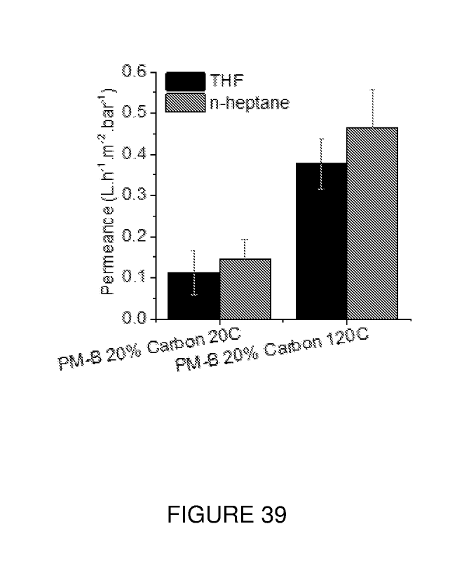

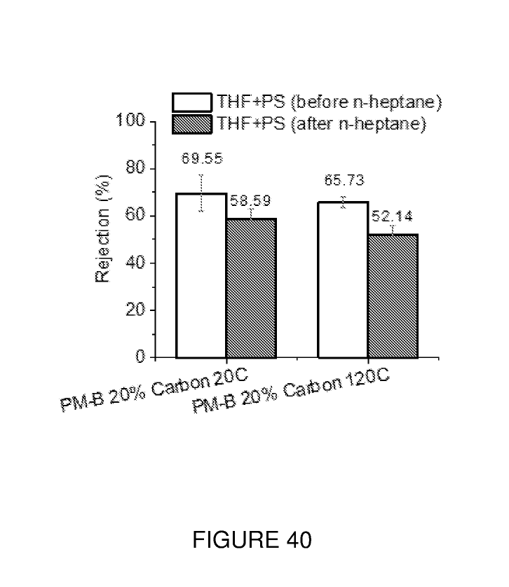

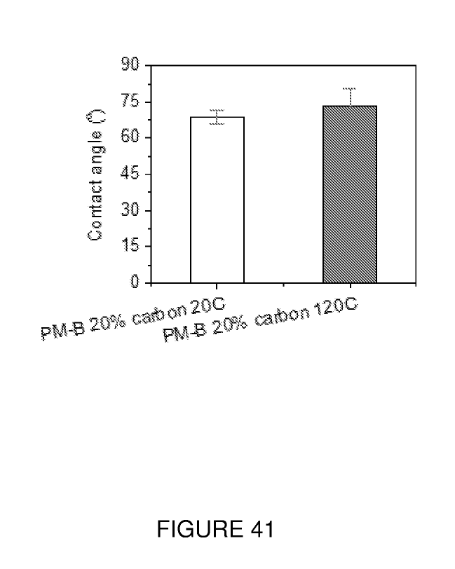

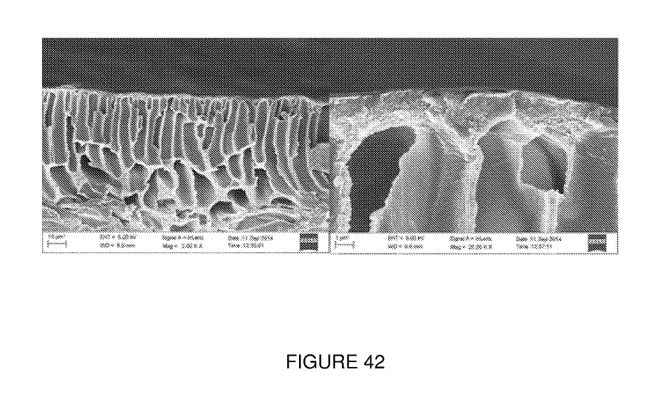

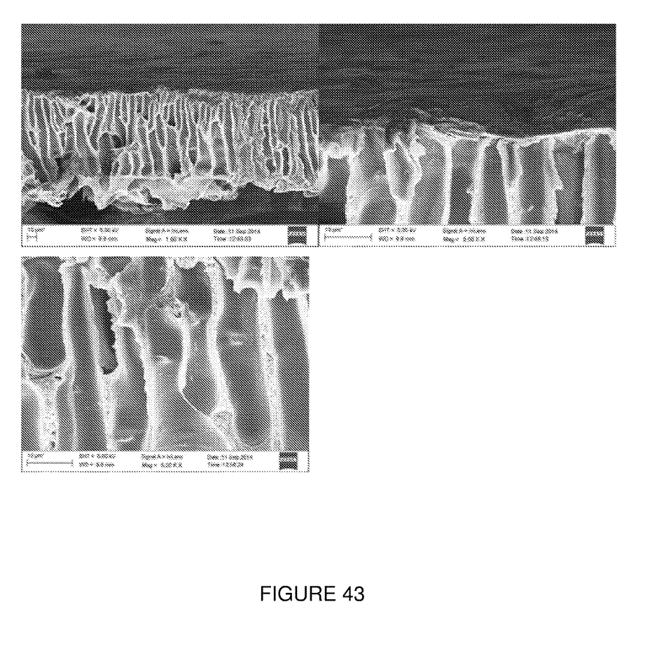

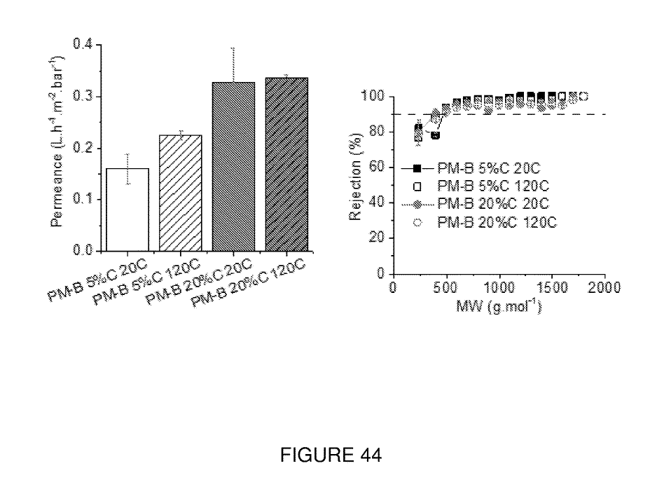

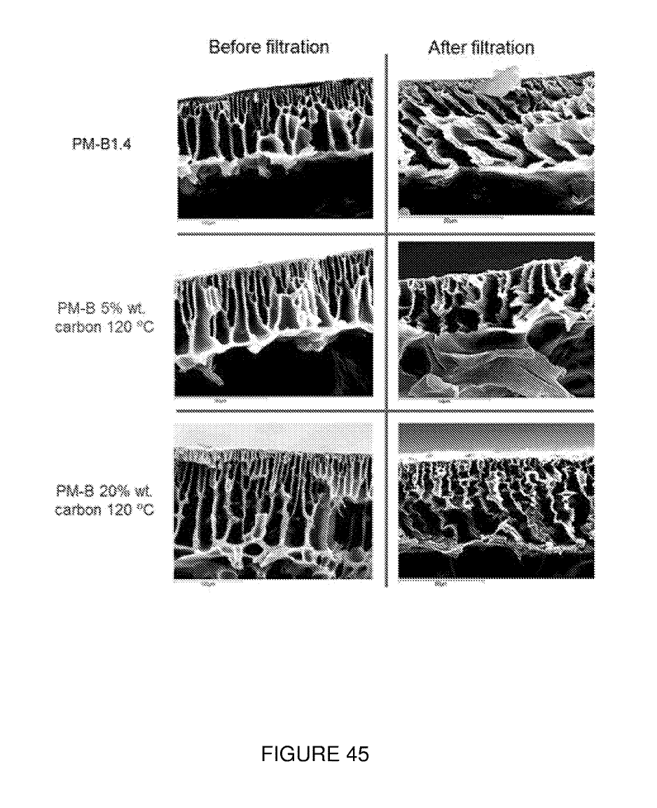

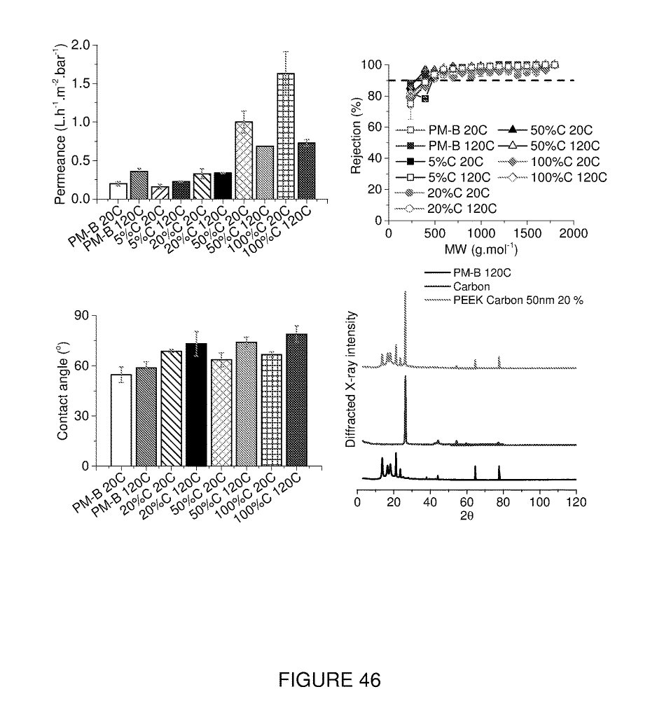

FIGS. 39 to 46 and Table 8 provide characterisation and performance data for graphite mixed matrix PEEK membranes prepared according the invention.

TABLE 8
Thickness of different PEEK membranes before and
after filtration and reduction of thickness (%).

| | Thickness (μm) | | | |
|---|---|---|---|---|
| | | | | Reduc- |
| | Before | After | Back- | tion |
| Sample | filtration | filtration | ing | (%) |
| PM-B 120° C. | 280 | 195 | 152 | 66.4 |
| PM-B carbon 5% wt. 120° C. | 207 | 170 | 142 | 56.9 |
| PM-B carbon 20% wt. 120° C. | 266 | 207 | 152 | 51.8 |
| PM-B 50% Carbon 20 C. | 213 | 195 | 160 | 34.0 |
| PM-B 50% Carbon 120 C. | 228 | 208 | 160 | 29.4 |
| PM-B 100% Carbon 20 C. | 194 | 189 | 160 | 14.7 |
| PM-B 100% Carbon 120 C. | 197 | 187 | 160 | 27.0 |

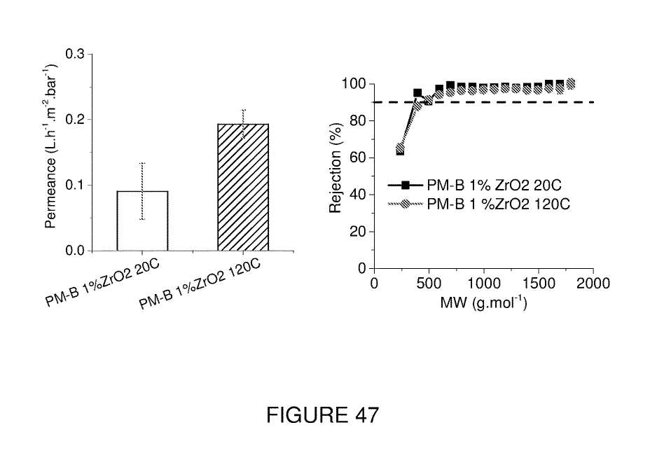

FIG. 47 provides performance data for ZrO₂ mixed matrix PEEK membranes prepared according the invention.

While specific embodiments of the invention have been described herein for the purpose of reference and illustration, various modifications will be apparent to a person skilled in the art without departing from the scope of the invention as defined by the appended claims.

### REFERENCES

[1] K. Vanherck, G. Koeckelberghs, I. F. J. Vankelecom, Crosslinking polyimides for membrane applications: A review, Prog Polym Sci, 38 (2013) 874-896.
[2] Y. H. See Toh, X. X. Loh, K. Li, A. Bismarck, A. G. Livingston, In search of a standard method for the characterisation of organic solvent nanofiltration membranes, In search of a standard method for the characterisation of organic solvent nanofiltration membranes, 291 (2007) 120-125.
[3] P. J. Rae, E. N. Brown, E. B. Orler, The mechanical properties of poly(ether-ether-ketone) (PEEK) with emphasis on the large compressive strain response, The mechanical properties of poly(ether-ether-ketone) (PEEK) with emphasis on the large compressive strain response, 48 (2007) 598-615.
[4] A. M. Diez-Pascual, G. Martinez, M. n. A. Gómez, Synthesis and Characterization of Poly(ether ether ketone) Derivatives Obtained by Carbonyl Reduction, Synthesis and Characterization of Poly(ether ether ketone) Derivatives Obtained by Carbonyl Reduction, 42 (2009) 6885-6892.
[5] http://www.performancefibers.com/PDFs/Europe/PF-PEEK-E.pdf, 2013, Performance Fibers
[6] http://www.performancefibers.com/PDFs/Europe/PF%20PEEK%20White%20Paper.%20Feb%202011.pdf, 2013, Performance Fibers
[7] L. Peeva, J. da Silva Burgal, S. Vartak, A. G. Livingston, Experimental strategies for increasing the catalyst turnover number in a continuous Heck coupling reaction, Experimental strategies for increasing the catalyst turnover number in a continuous Heck coupling reaction, 306 (2013) 190-201.
[8] N. Shibuya, R. S. Porter, A kinetic study of PEEK sulfonation in concentrated sulfuric acid by ultraviolet-visible spectroscopy, A kinetic study of PEEK sulfonation in concentrated sulfuric acid by ultraviolet-visible spectroscopy, 35 (1994) 3237-3242.
[9] M. A. M. Beerlage, Polyimide ultrafiltration membranes for non-aqueous systems, in, Enschede, 1994, pp. 211.
[10] W. MacDonald, C.-Y. Pan, 1974, METHOD FOR DRYING WATER-WET MEMBRANES, U.S. Pat. No. 3,842,515
[11] P. Manos, 1978, Membrane drying process, U.S. Pat. No. 4,080,743 A
[12] W. M. King, M.-W. Tang, C. G. Wensley, 1989, Air dried cellulose acetate membranes, U.S. Pat. No. 4,855,048 A
[13] D. Daoust, P. Godard, J. Devaux, R. Legras, C. Strazielle, Chemical modification of poly(ether ether ketone) for size exclusion chromatography at room temperature: 1. Absolute molecular-mass determination for sulfonated PEEK, Chemical modification of poly(ether ether ketone) for size exclusion chromatography at room temperature: 1. Absolute molecular-mass determination for sulfonated PEEK, 35 (1994) 5491-5497.
[14] D. Daoust, P. Godard, J. Devaux, R. Legras, C. Strazielle, Chemical modification of poly(ether ether ketone) for size exclusion chromatography at room temperature: 2. On the reliability of the derivatization procedure for PEEK molecular-mass determination—application to PEEK-carbon fibre composite, Chemical modification of poly(ether ether ketone) for size exclusion chromatography at room temperature: 2. On the reliability of the derivatization procedure for PEEK molecular-mass determination—application to PEEK-carbon fibre composite, 35 (1994) 5498-5503.
[15] P. Vandezande, L. E. M. Gevers, I. F. J. Vankelecom, Solvent resistant nanofiltration: separating on a molecular level, Solvent resistant nanofiltration: separating on a molecular level, 37 (2008) 365-405.
[16] G. Wypych, Knovel Solvents—A Properties Database, in, ChemTec Publishing,
[17] R. T. S. Muthu Lakshmi, V. Choudhary, I. K. Varma, Sulphonated poly(ether ether ketone): Synthesis and characterisation, Sulphonated poly(ether ether ketone): Synthesis and characterisation, 40 (2005) 629-636.
[18] N. Shibuya, R. S. Porter, Kinetics of PEEK sulfonation in concentrated sulfuric acid, Kinetics of PEEK sulfonation in concentrated sulfuric acid, 25 (1992) 6495-6499.
[19] J. N. Hay, J. I. Langford, J. R. Lloyd, Variation in unit cell parameters of aromatic polymers with crystallization temperature, Variation in unit cell parameters of aromatic polymers with crystallization temperature, 30 (1989) 489-493.
[20] Y. H. Lai, M. C. Kuo, J. C. Huang, M. Chen, On the PEEK composites reinforced by surface-modified nano-silica, On the PEEK composites reinforced by surface-modified nano-silica, 458 (2007) 158-169.
[21] X. Z. K. Loy, S. K. Sinha, Lubrication of polyether ether ketone (PEEK) surface by liquid ultrathin films for high wear durability, Lubrication of polyether ether ketone (PEEK) surface by liquid ultrathin films for high wear durability, 296 (2012) 681-692.
[22] C. Bailly, D. J. Williams, F. E. Karasz, W. J. MacKnight, The sodium salts of sulphonated poly(aryl-ether-ether-ketone) (PEEK): Preparation and characterization, The sodium salts of sulphonated poly(aryl-ether-ether-ketone) (PEEK): Preparation and characterization, 28 (1987) 1009-1016.
[23] I. M. Smallwood, Handbook of Organic Solvent Properties, in, Elsevier.
[24] G. L. Brown, Formation of films from polymer dispersions, Formation of films from polymer dispersions, 22 (1956) 423-434.

1. An asymmetric integrally-skinned nanofiltration membrane comprising a PAEK polymer, wherein the membrane has a degree of sulphonation of less than 40% and is suitable for performing nanofiltration in a polar aprotic organic solvent.

2. The membrane of claim 1, wherein the PAEK polymer is selected from the group consisting of PEK and PEEK.

3. The membrane of claim 1, wherein the PAEK polymer is PEEK.

4. The membrane of claim 1, wherein the membrane has a degree of sulphonation of less than 30%.

5. The membrane of claim 1, wherein the membrane has a degree of sulphonation of less than 10%.

6. The membrane of claim 1, wherein the membrane has a degree of sulphonation of less than 8%

7. The membrane of claim 1, wherein the membrane has a molecular weight cut off of 100-1000 g mol-1.

8. The membrane of claim 1, wherein the membrane has a molecular weight cut off of 200-750 g mol-1.

9. The membrane of claim 1, wherein the membrane has a molecular weight cut off of 400-600 g mol-1.

10. The membrane of claim 1, wherein the membrane has a permeance of 0.02-10 L h-1 m-2 bar-1.

11. The membrane of claim 1, wherein the membrane has a permeance of 0.05-0.9 L h-1 m-2 bar-1.

12. The membrane of claim 1, wherein the membrane has a permeance of 0.07-0.8 L h-1 m-2 bar-1.

13. The membrane of claim 1, wherein the PAEK polymer has a molecular weight of 25-60 kDa.

14. The membrane of claim 1, wherein the PAEK polymer has a molecular weight of 30-55 kDa.

15. The membrane of claim 1, wherein the membrane further comprises a conditioning agent.

16. The membrane of claim 15, wherein the conditioning agent is a low volatility organic liquid.

17. The membrane of claim 15, wherein the conditioning agent comprises at least one compound selected from the group consisting of synthetic oils, mineral oils, vegetable fats and oils, higher alcohols, glycerols and glycols.

18. The membrane of claim 15 wherein the conditioning agent is polyethylene glycol or silicone oil.

19. The membrane of claim 1, wherein the membrane has a thickness of 30-300 μm.

20. A process for the preparation of a membrane according to any preceding claim, the process comprising the steps of:
a) preparing a polymer solution comprising a solubilised PAEK polymer,
b) casting the polymer solution onto a support,
c) performing phase inversion of the cast polymer solution, and
d) exposing the resulting membrane to a temperature of 20-200° C.

21.-49. (canceled)
